(19) United States
(12) Patent Application Publication
(10) Pub. No.: US 2009/0058794 A1
(43) Pub. Date: Mar. 5, 2009

(54) LIQUID CRYSTAL DISPLAY DEVICE WITH IMPROVED DISPLAY LUMINANCE

(75) Inventor: Yoshihisa IWAMOTO, Yokohama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: STANLEY ELECTRIC CO., LTD, Tokyo (JP)

(21) Appl. No.: 12/199,996

(22) Filed: Aug. 28, 2008

(30) Foreign Application Priority Data
Aug. 31, 2007 (JP) 2007-225849
Sep. 12, 2007 (JP) 2007-236630
Nov. 5, 2007 (JP) 2007-287412

(51) Int. Cl. G09G 3/36

(52) U.S. Cl. 345/102

(57) ABSTRACT

A liquid crystal display device has: a liquid crystal display unit including a plurality of common electrodes to be sequentially applied with a drive voltage and segment electrodes for segment display, facing each common electrode, and a plurality of display areas divided for one or more common electrodes; a backlight including a multicolor light source provided for each display area; and a drive unit for performing field sequential driving of multiplex driving by scanning the plurality of common electrodes in such a manner that after all common electrodes in one display area are scanned, common electrodes in the next display area start being scanned, and by synchronizing scanning each common electrode with an emission operation of the multicolor light source in each display area.

### CROSS REFERENCE TO RELATED APPLICATION

This application is based on and claims priority of Japanese Patent Applications No. 2007-225849 filed on Aug. 31, 2007, No. 2007-236630 filed on Sep. 12, 2007, and No. 2007-287412 filed on Nov. 5, 2007, the entire contents of which are incorporated herein by reference.

### BACKGROUND OF THE INVENTION

A) Field of the Invention

The present invention relates to a liquid crystal display device, and more particularly to a liquid crystal display device under field sequential driving.

B) Description of the Related Art

A liquid crystal display device capable of segment display or segment display together with dot matrix display is used in a display unit or the like of a vehicle mounted information display device or a car audio apparatus. One of liquid crystal display devices capable of color segment display has the structure that white backlight is radiated to a liquid crystal display unit formed with color filters.

Disadvantages of a liquid crystal display device with color filters are a necessity of forming color filters on a glass substrate of a liquid crystal display unit, a limit of each segment color to colors of the color filters, and the like.

Another liquid crystal display device capable of color segment display is a device under so-called field sequential (FS) driving. A liquid crystal display device of this type does not have color filters of a liquid crystal display unit, but realizes desired color display by time sequentially switching emission color, using a multicolor backlight constituted of a multicolor light emitting diode (LED) capable of emission of, e.g., red, green and blue (RGB).

With reference to FIG. 18, description will be made on a specific example of a conventional FS driving method. FIG. 18 is a timing chart illustrating timings of each segment input signal and backlight emission. It is assumed that a liquid crystal display unit is a normally black type that light is transmitted in an on-state and not transmitted in an off-state.

One frame representative of a time unit of displaying one image is constituted of three subframes SB1 to SB3 during which the backlight emits R, G and B colors. For example, one frame time is 16.7 ms in conformity with the NTSC specifications, and a time of each subframe is 5.57 ms which is a division of one frame by 3.

A drive waveform applied to a liquid crystal display unit is, e.g., a rectangular wave, and its drive frequency is set to have one or more periods in one subframe, and its amplitude (drive voltage) during an on/off state is adjusted to allow the liquid crystal display unit to display a bright/dark state corresponding to an input signal.

Generally, a liquid crystal display unit has a slower response to an applied voltage than that of a backlight, it is necessary to provide a blank time not turning on the backlight until the liquid crystal display unit responds to some degree.

FIG. 19 shows an example of measurements of an electrooptical fall response when one segment of a normally black type liquid crystal display unit changes from bright display to dark display. An upper portion of the ordinate represents a transmissivity, a lower portion of the ordinate represents a potential of a drive waveform between upper and lower electrodes of the segment, and the abscissa represents a lapse time.

It can be seen that even if a drive voltage changes from a voltage V not smaller than a threshold value to 0 V, a transmissivity does not lower sufficiently at once. If the backlight of designated color is tuned on in a subframe in the state that the transmissivity does not lower sufficiently, color purity lowers because color emission in this segment to be extinguished leaks. It is therefore necessary to provide a blank time not turning on the back light, until the transmissivity lowers sufficiently.

Reverting to FIG. 18, description will be made further. A blank time B is provided immediately after switching each subframe. A backlight emission time L is set to a period after the blank time B to each subframe end time, to turn on the backlight of color corresponding to each subframe.

If a subframe operation is performed at speed not recognized by human eyes (e.g., about 16.7 ms/frame, about 5.57 ms/subframe, and about 3 ms/blank time), color display suppressing flicker can be realized as intended. In the example shown in FIG. 18, a segment 1 is recognized as yellow which is mixture color of R and G, a segment 2 is recognized as magenta which is mixture color of R and B, and a segment n is recognized as green G, by human eyes.

With the above-described FS driving method (hereinafter called a normal FS driving method in order to distinguish it from a color break-less FS driving method), however, there may arise a phenomenon called color break in which an image of each subframe not recognized by human eyes in a normal state is separated and observed by human eyes. This phenomenon occurs particularly when an environment of an observer is dark, in a state that visual axes of an observer depart from the display unit, in a state that vibrations are applied to the display unit (e.g., in an environment in a vehicle) and in other states. It can be said that this phenomenon provides a display state not so much preferable in terms of human psychological factors.

The color break phenomenon occurs clearly particularly in a white display area. Therefore, the color break phenomenon is considered to be recognized remarkably if an emission operation is performed in a plurality of subframes for one segment by the normal FS driving method, i.e., in a mixture color display state of white, yellow or magenta.

As a method of reducing the color break phenomenon, methods have been proposed such as a method of inserting a white display subframe in one frame. These methods, however, cannot eliminate the color break phenomenon.

The present inventor and his colleagues have proposed an FS driving method capable of eliminating the color break phenomenon (this method is hereinafter called the color break-less FS driving method in order to distinguish it from the above-described normal FS driving method) in Japanese Patent Publication No. 3894323, the entire contents of which are incorporated herein by reference.

A fundamental concept of this driving method is to eliminate the color break phenomenon by using not only primary colors (R, G and B) but also mixture colors (such as white and orange) as backlight emission colors in one subframe, and performing emission of backlight only in one subframe for each segment.

With reference to FIG. 20, a specific example of the color break-less FS driving method will be described. FIG. 20 is a timing chart illustrating timings of each segment input signal and a backlight emission state. It is assumed that the liquid crystal display unit is a normally black type.

In this example, a backlight emission color is white for a subframe 1, orange for a subframe 2, and blue for a subframe 3. With this driving method, the number of colors allowable in each frame is M+1 colors including black added to M emission colors corresponding to the number of subframes M.

Since backlight emission color can be changed for each frame, it is obvious that the number of display colors can be increased considerably more than the above-described normal FS driving method, if the operation of the liquid crystal display unit is binary bright/dark display.

In this example, one frame is 16.7 ms, and three subframes of the same time duration are set. A time duration of each subframe may be changed in accordance with emission color of the backlight. Namely even if subframe have different time durations, an operation is possible.

A segment 1 displays white, a segment 2 displays black, and a segment n displays orange. Similar to the normal FS driving method, a blank time B of about 3 ms for waiting for an electrooptical response of the liquid crystal display unit is provided immediately after subframe switching. A backlight emission time L is to a period after the blank time B to the subframe end time to turn on the backlight of color corresponding to the subframe.

With these operations, it becomes possible to realize color display without flicker and color break as intended when viewed externally.

### SUMMARY OF THE INVENTION

An object of the present invention is to provide a liquid crystal display device with improved display luminance.

Another object of the present invention is to provide a liquid crystal display device FS driving of multiplex driving capable of suppressing display luminance from being lowered even if the number of common electrodes is increased.

Still another object of the present invention is to provide a liquid crystal display device under color break-less FS driving capable of improving display luminance and increasing the number of display colors.

Still another object of the present invention is to provide a liquid crystal display device having a display unit of segment display or mixture of segment display and dot matrix display, under color break-less FS driving capable of improving display luminance and color purity even with multicolor display.

According to one aspect of the present invention, there is provided a liquid crystal display device comprising: a liquid crystal display unit including a plurality of divided display areas; a backlight having a light source provided for each of said plurality of divided display areas; and a drive unit for synchronizing a display state of said liquid crystal display unit and an emission state of said backlight.

### BRIEF DESCRIPTION OF THE DRAWINGS

FIG. 1 is a schematic diagram showing the structure common to liquid crystal display devices according to embodiments of the present invention.

FIG. 2A is a schematic perspective view of an NWTN mode liquid crystal display unit. FIG. 2B is a schematic cross sectional view showing an example of the structure of a glass substrate, and FIG. 2C is a schematic cross sectional view showing another example of the structure of a glass substrate.

FIG. 3 is a schematic perspective view of a two-layer TN mode liquid crystal display unit.

FIG. 4 is a schematic perspective view of a VA mode liquid crystal display unit.

FIGS. 5A and 5B are plan views showing display patterns and display areas according to a first embodiment.

FIG. 6 is a schematic cross sectional view showing an example of the structure of a backlight.

FIG. 7 is a schematic cross sectional view showing another example of the structure of a backlight.

FIG. 8 is a timing chart showing timings of drive waveforms of common electrodes and backlight emission of the first embodiment.

FIGS. 9A and 9B are plan views showing display patterns and display areas according to a second embodiment.

FIG. 10 is a timing chart showing timings of drive waveforms of common electrodes and backlight emission of the second embodiment.

FIGS. 11A and 11B are plan views showing display patterns and display areas according to a third embodiment.

FIG. 12 is a timing chart showing timings of drive waveforms of common electrodes and backlight emission of the third embodiment.

FIGS. 13A and 13B are plan views showing display patterns and display areas according to a fourth embodiment.

FIG. 14 is a timing chart showing timings of drive waveforms of common electrodes and backlight emission of the fourth embodiment.

FIGS. 15A and 15B are tables showing a list of electrooptical response characteristics of an NWTN display unit, a two-layer display unit and a VA display unit.

FIG. 16 is a timing chart showing timings of drive waveforms of common electrodes and backlight emission according to a fifth embodiment.

FIG. 17 is a timing chart showing timings of drive waveforms of common electrodes and backlight emission according to a sixth embodiment.

FIG. 18 is a timing chart showing timings of segment input signals and backlight emission by a conventional normal FS driving method.

FIG. 19 is a graph showing an electrooptical fall response during switching from bright display to dark display of one segment of a normally black type liquid crystal display unit.

FIG. 20 is a timing chart showing timings of segment input signals and backlight emission by a conventional color break-less FS driving method.

FIG. 21 is a timing chart showing timings of drive waveforms and backlight emission by a conventional static FS driving method.

FIG. 22 is a timing chart showing timings of drive waveforms of common electrodes and backlight emission by a conventional 1/2 duty multiplex FS driving method.

FIG. 23 is a timing chart showing timings of drive waveforms of common electrodes and backlight emission by a conventional 1/4 duty multiplex FS driving method.

FIGS. 24A and 24B are plan views showing display patterns and display areas of a liquid crystal display device according to a seventh embodiment.

FIG. 25 is a timing chart showing timings of drive waveforms of segment electrodes and backlight emission of the seventh embodiment.

FIGS. 26A and 26B are plan views showing display patterns and display areas of a liquid crystal display device according to an eighth embodiment.

FIG. 27 is a timing chart showing timings of drive waveforms of common and segment electrodes and backlight emission of the eighth embodiment.

FIG. 28 is a timing chart showing timings of drive waveforms of segment electrodes and backlight emission according to a ninth embodiment.

FIG. 29 is a timing chart showing timings of drive waveforms of common and segment electrodes and backlight emission according to a tenth embodiment.

FIG. 30 is a plan view showing names of segments of a 7-segment display unit.

FIG. 31 is a timing chart showing timings of drive waveforms of segment electrodes and backlight emission according to a comparative example (with the 7th embodiment).

FIG. 32A shows a display pattern example 1 of a liquid crystal display unit. FIG. 32B is an assignment example 1 of a backlight area, and FIG. 32C is a wiring diagram of common electrodes.

FIG. 33 is a timing chart showing drive waveforms applied to common electrodes 1 to 4 and segment electrode 1 to 6 during one frame, and emission colors and timings of backlight areas A and B.

FIG. 34 shows an assignment example 2 of a backlight area.

FIG. 35 is a timing chart showing drive waveforms applied to common electrodes 1 to 4 and segment electrode 1 to 6, and emission colors and timings of backlight areas A, B and C.

FIG. 36 is a timing chart showing drive waveforms applied to common electrodes 1 to 4 and segment electrode 1 to 6 during one frame, and emission colors and timings of backlight areas A and B.

FIG. 37 is a timing chart showing drive waveforms applied to common electrodes 1 to 4 and segment electrode 1 to 6 during one frame, and emission colors and timings of backlight areas A and B.

FIG. 38A shows a display pattern example 2, FIG. 38B is an assignment example 3 of a backlight area and FIG. 38C is a wiring diagram of common electrodes.

FIG. 39 shows a display pattern example 3.

### DESCRIPTION OF THE PREFERRED EMBODIMENTS

First, description will be made on liquid crystal display devices according to first to sixth embodiments of the present invention.

Prior to description of the first to sixth embodiments, comparison will be made on a difference between static driving and multiplex driving. First, a case will be described wherein a static drive waveform is applied to a segment display unit.

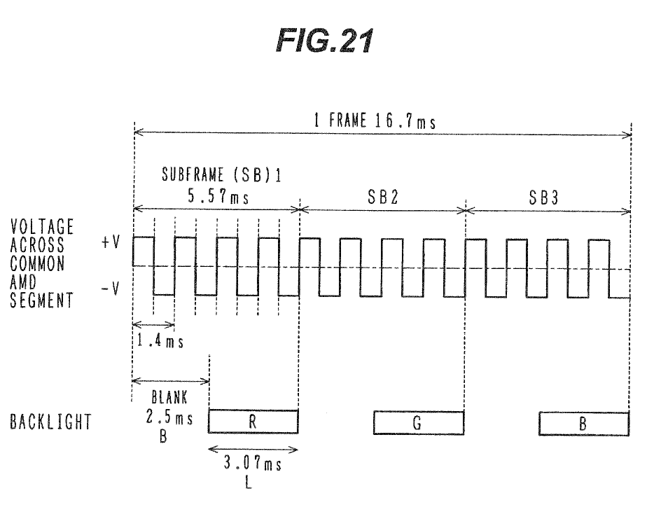

FIG. 21 is a timing chart showing examples of timings of a drive waveform and backlight emission. It is assumed that a normally black type liquid crystal unit is driven by a normal FS driving method. A drive waveform for a segment display unit is a rectangular wave at a frequency of about 720 Hz. One frame is set to 16.7 ms, and each of three subframes for RGB emission is set to 5.57 ms. A blank time B is 2.5 ms immediately after subframe switching. A backlight emission time L is 3.07 ms after the blank time to the subframe end time.

If there are a plurality of scan lines (common electrodes) and each segment display unit does not have a switching element such as a thin film transistor (TFT), multiplex driving is required to sequentially scan a plurality of scan lines. In order to obtain a uniform display state in multiplex driving, the backlight cannot be turned on even during a scan standby time.

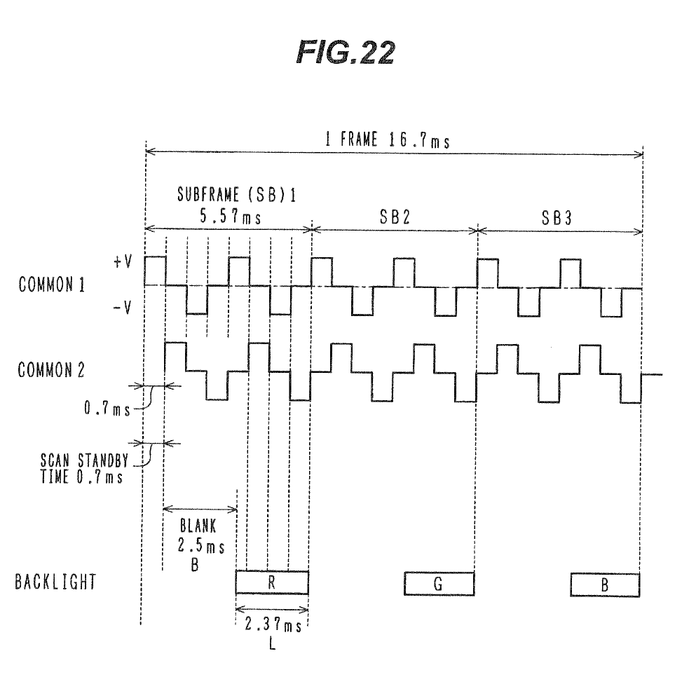

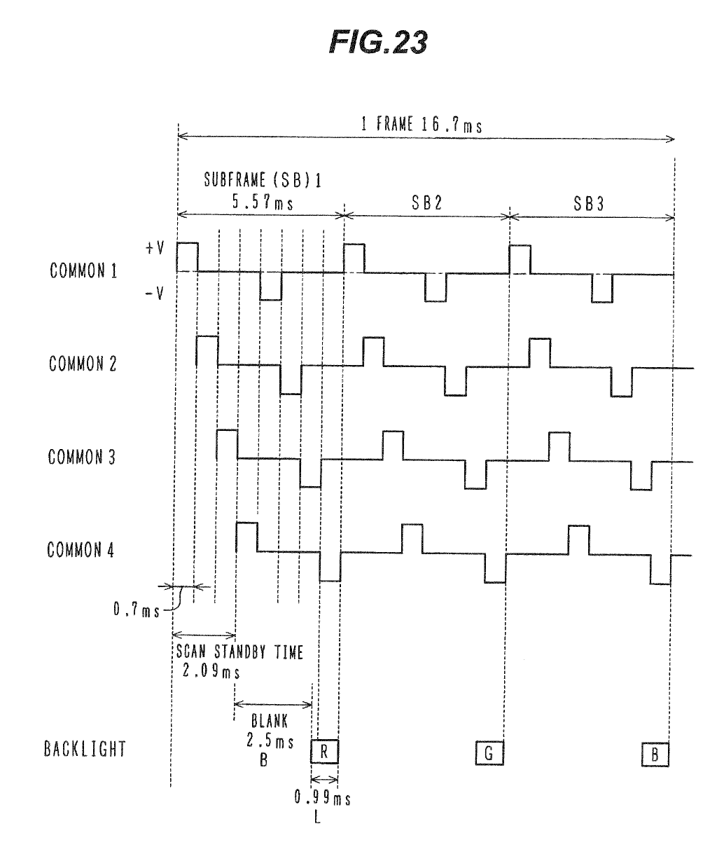

FIGS. 22 and 23 are timing charts showing examples of timings of drive waveforms to be applied to common electrodes and backlight emission. The timing chart of FIG. 22 shows multiplex driving at a 1/2 duty and a 1/2 bias with two common electrodes. The timing chart of FIG. 23 shows multiplex driving at a 1/4 duty and a 1/3 bias with four common electrodes.

The normal FS driving method is assumed, one frame is set to 16.7 ms, each of three subframes for RGB emission is set to 5.57 ms, and a blank time B is set to 2.5 ms.

A drive frequency at the 1/2 duty shown in FIG. 22 is 360 Hz, and a drive frequency at the 1/4 duty shown in FIG. 23 is 180 Hz. A scan time per common electrode is about 0.7 ms, and a scan standby time per subframe is a time required to scan common electrodes corresponding in number to the total number of common electrodes subtracted by “1”.

In the case of two common electrodes shown in FIG. 22, a scan standby time is about 0.7 ms, and after the next blank time of 2.5 ms, the backlight is turned on. Therefore, the backlight emission time L is about 2.73 ms. Since the scan standby time exists, the backlight emission time is shortened more than the backlight emission time of 3.07 ms of static driving, and a display luminance lowers.

In the case of four common electrodes shown in FIG. 23, a scan standby time is prolonged to about 2.09 ms, and after the next blank time of 2.5 ms, the backlight is turned on. Therefore, the backlight emission time L is about 0.99 ms, so that the display luminance lowers more than the case of two common electrodes.

As described above, as a duty number increases, the scan standby time is prolonged so that the display luminance of the multiplex FS driving liquid crystal display device lowers. Further, as the duty number increases in multiplex driving, an on/off voltage ratio becomes small and a response speed lowers. Therefore, if the blank time is not prolonged correspondingly, a display state with good color purity cannot be realized.

It has been long desired to provide techniques capable of suppressing a display luminance from being lowered, even if the number of common electrodes is increased in the multiplex, FS driving liquid crystal device.

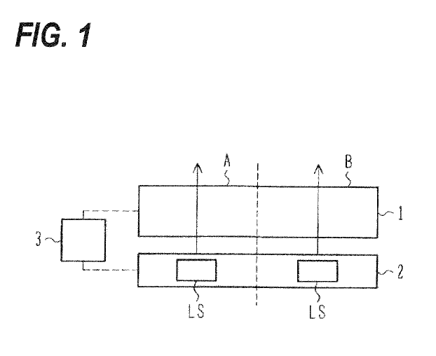

Next, with reference to FIG. 1, description will now be made on the structure common to liquid crystal display devices according to the first to sixth embodiments. FIG. 1 is a schematic diagram showing the structure of a liquid crystal display device. The liquid crystal display device is constituted of a liquid crystal display unit 1, a backlight 2 and a drive unit 3.

Each of the liquid crystal display units of the first to sixth embodiments includes a plurality of common electrodes, and opposing segment electrodes for segment display. The display screen is divided into display areas A, B and the like respectively for one or more common electrodes.

The backlight 2 is disposed on the back of the liquid crystal display unit 1, and includes a multicolor light source LS disposed for each display area and a light distribution control structure for making light emitted from each multicolor light source LS be radiated only to a corresponding display area. Each multicolor light source LS is constituted of a light source of a plurality of colors, e.g., a multicolor light emitting diode (LED) capable of emission of red, green and blue (RGB) colors. Each multicolor light source LS can be turned on at an independent timing.

The drive unit 3 synchronously drives the liquid crystal display unit 1 and multicolor light source LS at desired timings to obtain color display of multiplex field sequential (FS) driving.

The liquid crystal display unit 1 may be a normally white (NW) twisted nematic (TN) mode liquid crystal display unit, a two-layer TN mode liquid crystal display unit or a vertical alignment (VA) mode liquid crystal display unit.

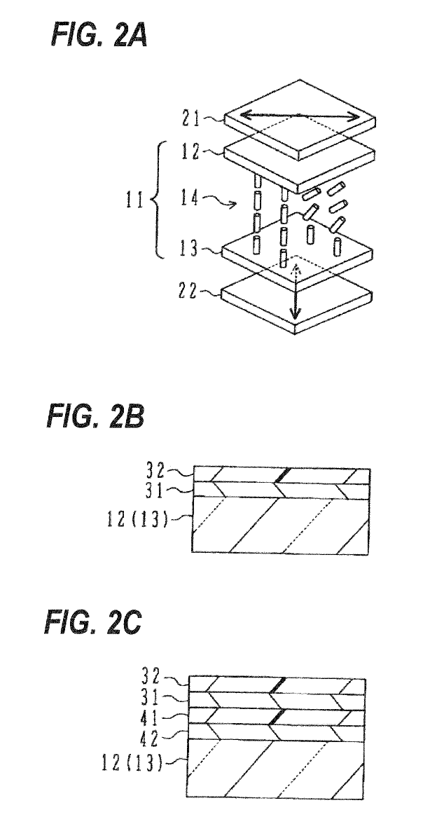

With reference to FIGS. 2A to 2C, description will be made on an NWTN mode liquid crystal display unit. FIG. 2A is a schematic perspective view of an NWTN mode liquid crystal display unit. A liquid crystal cell 11 is constituted of upper and lower glass substrates 12 and 13 and a liquid crystal layer 14 formed between the substrates.

As shown in FIG. 2B, a transparent electrode 31 having a pattern corresponding to a display pattern is disposed on the inner surface of each of the glass substrates 12 and 13 of the liquid crystal cell, and a horizontal alignment film 32 is formed on the transparent electrode. Upper and lower horizontal alignment films 32 are subjected to a rubbing process to align liquid crystal molecules at left twist of 90° between upper and lower substrates.

The liquid crystal layer 14 is formed by making a space between the upper and lower horizontal alignment films 31 and 32 be filled with liquid crystal material of Δε>0 added with left twist chiral material. A thickness of the liquid crystal layer 14, i.e., a cell thickness, is set to about 2 μm and a ratio d/p of the liquid crystal cell thickness d and a liquid crystal material twist pitch p is set to about 0.35. A retardation Δnd, a product of the liquid crystal material birefringence Δn and the cell thickness d, is set to about 446 nm. The rubbing direction is adjusted in such a manner that a molecule alignment direction at the center of the liquid crystal layer in a thickness direction is a 6 o'clock direction in the device in-plane as the liquid crystal display unit is viewed along a normal direction.

The liquid crystal cell 11 is disposed between an upper polarizer 21 and a lower polarizer 22 cross-Nicol disposed. An absorption axis of each of the polarizers 21 and 22 is set perpendicular to a rubbing direction of the adjacent substrate of the liquid crystal cell 11. The polarizers 21 and 22 are made of, for example, SKN18243T manufactured by Polatechno Co., Ltd.

In order to improve visual angle characteristics of a liquid crystal display unit, a black mask film is disposed in some cases in an area other than the display pattern area of one or both glass substrates, the black mask film being electrically insulated from the display pattern electrodes by non-conductive material. The black mask film is made of a metal thin film of, e.g., chromium or molybdenum. A resin film such as acrylic dispersed with pigment and carbon may be used as the black mask film.

As shown in FIG. 2C, an insulating film 41 and a black mask film 42 are formed, for example, between the glass substrate 12 (13) and transparent electrode 31 of the liquid crystal cell. If necessary, these films may be formed between the transparent electrode 31 and alignment film 32. It is preferable to use this light shielding structure for the liquid crystal display device particularly under color break-less FS driving.

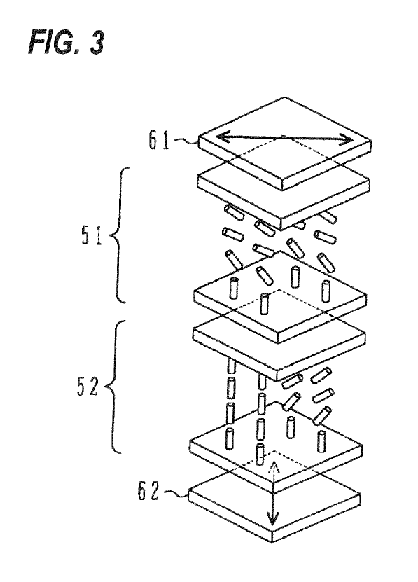

Next, with reference to FIG. 3, a two-layer TN mode liquid crystal display unit will be described. FIG. 3 is a schematic perspective view of a two-layer TN mode liquid crystal display unit. An upper polarizer 61 and a lower polarizer 62 are cross-Nicol disposed. The polarizers 61 and 62 may be made of SKN18243T manufactured by Polatechno Co., Ltd. Two liquid crystal cells 51 and 52 are disposed between the polarizers 61 and 62 in this order from the upper side.

The lower liquid crystal cell 52 is equivalent to the NWTN mode liquid crystal cell described with reference to FIG. 2A, and is operated as a “drive cell”. The drive cell 52 is used for switching bright/dark of the display unit by applying externally a drive voltage to this cell.

The upper liquid crystal cell 51 is used as a “compensation cell”. The rubbing direction is set so that liquid crystal molecules of the compensation cell 51 are aligned at right twist of 90° between upper and lower substrates. Chiral material inducing right twist is added to the liquid crystal layer of the compensation cell 51, and an alignment direction of molecules at the center of the liquid crystal layer in a thickness direction is set to a 3 o'clock direction. Display pattern electrodes are not formed on the surface of the glass substrate of the compensation cell 51. Other conditions are similar to those of the drive cell 52.

A retardation generated in the drive cell 52 is cancelled out by the compensation cell 51 so that a retardation becomes approximately 0 through front observation, and dark display approximately equal to that by the cross-Nicol disposed polarizers can be obtained. By using a two-layer liquid crystal cell, normally black (NB) operation can be realized.

It is obvious that an optical film having similar optical characteristics to those of the compensation cell, e.g. a Twistar film manufactured by Polanotechno Co., Ltd, can be used in place of the compensation cell. It has already been confirmed that similar operations are possible by applying the optical film to an actual liquid crystal display unit.

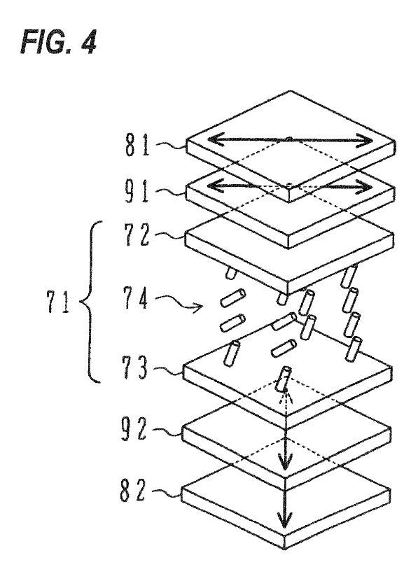

Next, with reference to FIG. 4, a vertical alignment (VA) mode liquid crystal display unit will be described. FIG. 4 is a schematic perspective view of a VA mode liquid crystal display unit. A transparent electrode having a desired pattern is disposed on the inner surface of each of upper and lower glass substrates 72 and 73 of a liquid crystal cell 71 of the VA mode liquid crystal display unit, and a vertical alignment film is formed on the transparent electrode. Upper and lower vertical alignment films are subjected to a rubbing process to align liquid crystal molecules antiparallel between upper and lower substrates.

A liquid crystal layer 74 is formed by making a space between the upper and lower vertical alignment films be filled with liquid crystal material of Δε<0. A thickness of the liquid crystal layer 74 is set to about 2 μm, a retardation Δnd is set to about 300 nm, and an alignment direction of molecules at the center of the liquid crystal layer in a thickness direction is set to a 12 o'clock direction.

The liquid crystal cell 71 is disposed between an upper polarizer 81 and a lower polarizer 82 cross-Nicol disposed. An absorption axis of the upper polarizer 81 is set at a position rotated counter clockwise by 45° from a 12 o'clock direction.

Visual angle compensation plates 91 and 92 are disposed between the liquid crystal cell 71 and upper and lower polarizers 81 and 82. An optical film having a negative biaxial optical anisotropy may be used as the visual angle compensation plates 91 and 92. In the liquid crystal display unit manufactured as a sample, a polarizer bonded with a visual angle compensation plate was used which was formed by bonding an optical film having negative biaxial optical anisotropy to an iodine-containing polarizer manufactured by Sumitomo Chemical Co., Ltd.

In-plane lag axes of the visual angle compensation plates 91 and 92 are set approximately parallel to the transmission axes of adjacent polarizers 81 and 82, respectively. Each of the visual angle compensation plates 91 and 92 has an in-plane phase difference of about 45 nm and a phase difference in a thickness direction (in a thickness cross section) of about 120 nm.

The visual angle compensation plate having negative biaxial optical anisotropy may be disposed on one of the upper and lower surfaces of the liquid crystal cell. On the other surface, a visual angle compensation plate having negative uniaxial optical anisotropy may be disposed. A phase difference (a total sum of differences if two optical films are used) in a thickness direction, as a parameter of the optical film, is preferably set to about a 0.5-fold to 1-fold of Δnd of the liquid crystal cell. An in-plane phase difference of the optical film having negative biaxial optical anisotropy is preferably set to about 30 nm to about 65 nm.

The two-layer TN unit and VA unit are normally black type units. By using the normally black type unit, it becomes easy to manufacture a color break-less FS driving liquid crystal display device having a high contrast, with the structure not using a black mask. Since the VA unit in particular has excellent visual angle characteristics, this unit is suitable for improving a display quality.

Next, description will be made on liquid crystal display devices of the first to fourth embodiments having a variety of display patterns and the like.

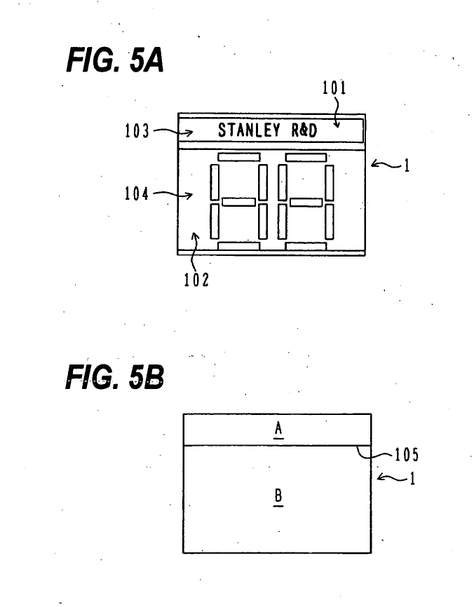

First, description will be made on the liquid crystal display device of the first embodiment under multiplex driving at a 1/2 duty and a 1/2 bias. FIG. 5A shows a display pattern of a liquid crystal display unit 1. The liquid crystal display unit 1 of the first embodiment has two common electrodes 101 and 102, a 1-segment display unit 103 for displaying a character string of “STANLEY R & D” and a 7-segment display unit 104 of two digits. Segment electrodes of the display unit 103 and 104 face the common electrodes 101 and 102, respectively.

FIG. 5B shows a display area. The display screen is divided into two display areas A and B. The display areas A and B are inclusive of display units 103 and 104 as viewed in plan, respectively, and have shapes defined approximately by the outer contours of the common electrodes 101 and 102, respectively. A border 105 between the display areas A and B is disposed at the center between the lower end of the display unit 103 (STANLEY R & D) and the upper end of the display unit 104 (7-segment display unit of two digits).

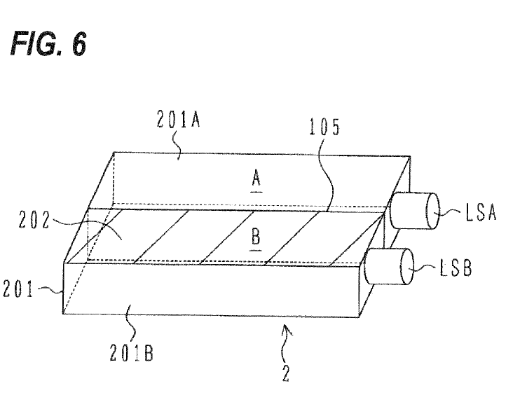

FIG. 6 shows an example of the structure of a backlight 2. This example shows the structure of a side light type backlight. A reflection plate 202 made of, e.g., metal, is inserted into a light guide plate 201 just under the border 105 between the display areas A and B, to divide the light guide plate 201 into a portion 201A on the display area A side and a portion 201B on the display area B side.

A multicolor light source LSA is disposed at the end of the portion 201A of the light guide plate 201 on the display area A side, and a multicolor light source LSB is disposed at the end of the portion 201B on the display area B side. Since the reflection plate 202 is formed, light beams emitted from the multicolor light sources LSA and LSB are radiated only to the display area A and display area B, respectively, without being mixed.

It is preferable that the space between the display units 103 and 104 is sufficiently broad in order that the display unit 103 in the display area A and the display unit 104 in the display area B are illuminated separately by the multicolor light sources LSA and LSB, respectively. A shortest distance between the display units included in adjacent display areas (shortest distance between display pixels) is preferable not shorter than 1 mm and more preferably not shorter than 2 mm. In this embodiment, a shortest distance between the lower end of the display unit 103 (STANLEY R & D) and the upper end of the display unit 104 (7-segment display unit of two digits) (a shortest distance between the display units 103 and 104) is set to 2.5 mm.

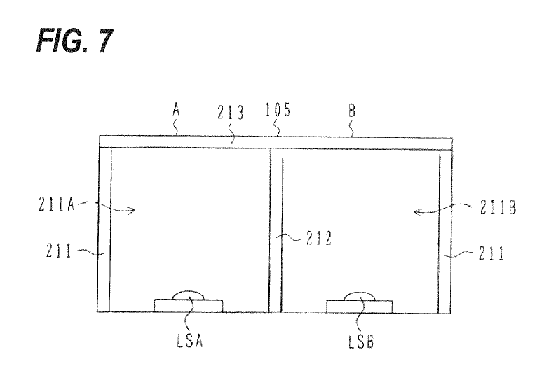

The backlight structure is not limited to the side light type. For example, as shown in FIG. 7, a so-called just-under type backlight may be used. A box-shaped structural body having a side wall 211 for light diffusion and reflection is partitioned into a unit 211A on the display area A side and a unit 211B on the display area B side, by a partition wall 212 for light diffusion and reflection. The partition wall 212 is disposed just under a border 105 between the display areas A and B.

A multicolor light source LSA is installed on the bottom of the unit 211A on the display area A side, and a multicolor light source LSB is installed on the bottom of the unit 211B on the display area B side. Light beams emitted from the multicolor light sources LSA and LSB illuminate only the display areas A and B, respectively, via a diffusion plate 213, without being mixed because of presence of the partition wall 212.

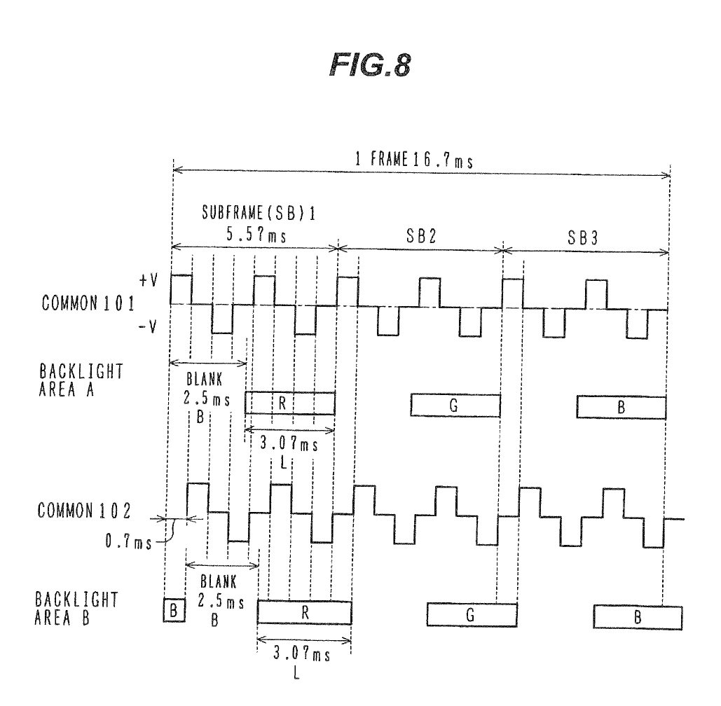

FIG. 8 is a timing chart showing timings of drive waveforms of the common electrodes 101 and 102 and backlight emission in the display areas A and B, respectively of the liquid crystal display device of the first embodiment. One frame was set to 16.7 ms and divided at an equal pitch into three subframes SB1 to SB3 of 5.57 ms for RGB emission. A drive frequency of multiplex driving waveforms to be applied to the liquid crystal display unit was set to about 360 Hz. A scan time per common electrode is about 0.7 ms. A blank time B was set to 2.5 ms. The display areas A and B are scanned in this order.

Only one common electrode 101 belongs to the display area A. Since it is not necessary to scan a plurality of common electrodes, in the display area A, a blank time B can be set from the start time when a drive waveform is applied to the common electrode 101, i.e., from the start time of a subframe. A backlight emission time L is set after the blank time B to the end time of the subframe. The backlight emission time L is about 3.07 ms.

After about 0.7 ms from the start time when the drive waveform is applied to the common electrode 101 belonging to the display area A, a drive waveform, starts being applied to the common electrode 102 belonging to the display area B. Only one common electrode 102 is used also for the display area B, and it is unnecessary to scan a plurality of common electrodes similar to the display area A.

Therefore, a drive for the display area B is same as that for the display area A shifted by a scan time per common electrode of about 0.7 ms. A backlight emission time of about 3.07 ms can be retained also for the display area B. Since the backlight emission time is equal in both the display areas A and B, a display luminance can be made uniform.

If the display screen is not divided into a plurality of display areas, all common electrodes are scanned in one subframe, a long scan standby time is required and it is difficult to retain a long backlight emission time. As in this embodiment, the display screen is divided into a plurality of display areas for one (or more) common electrodes to reduce the number of common electrodes to be scanned in each subframe, so that a long backlight emission time can be retained.

Furthermore, since one common electrode belongs to each display area, there is no scan standby time in the subframe, and the blank time can be set immediately after the subframe start. For example, as described with reference to FIG. 22, a longer emission time can be retained as compared to a driving method required to scan a plurality of common electrodes in the subframe, so that a display luminance can be improved.

Visual states were observed by manufacturing the liquid crystal display device under FS driving shown in the timing chart of FIG. 8 and a conventional liquid crystal display device under FS driving shown in the timing chart of FIG. 22. An NWTN unit was used as the liquid crystal display unit. Although color purity was similar for both the embodiment and conventional units, it was confirmed that a display luminance of the embodiment was improved definitely.

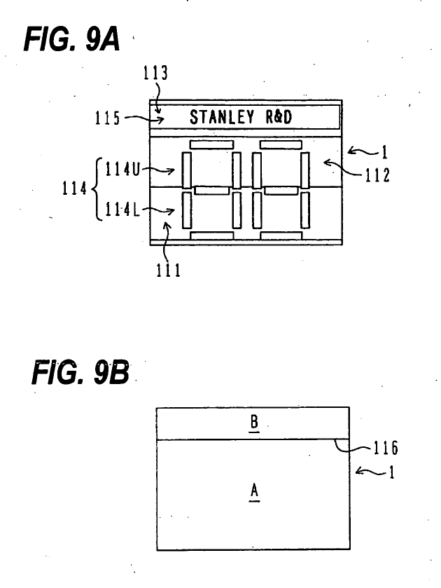

Next, description will be made on the liquid crystal display device of the second embodiment under multiplex driving at a 1/3 duty and a 1/3 bias. FIG. 9A shows a display pattern of a liquid crystal display unit 1. In the second embodiment, although the display pattern is the same as that of the first embodiment, electrode wiring patterns are different.

The liquid crystal display unit of the second embodiment has three common electrodes 111 to 113, a 7-segment display unit 114 of two digits and a 1-segment display unit 115 for displaying a character string of “STANLEY R & D”. The 7-segment display unit of two digits is divided into an lower 4-segment display unit 114L and an upper 3-segment display unit 114U. Segment electrodes of the display units 114L, 114U and 115 face the common electrodes 111, 112 and 113, respectively.

FIG. 9B shows a display area. The display screen is divided into two display areas A and B. The display area A is inclusive of the display units 114L and 114U, i.e., the 7-segment display unit 114 of two digits, and has a shape defined approximately by the outer contour of a set of the common electrodes 111 and 112. The display area B is inclusive of the character display unit 115 and has a shape defined approximately by the outer contour of the common electrode 113.

A border 116 between the display areas A and B is defined in a manner similar to the first embodiment. Similar to the first embodiment, a distance between the lower end of the display unit 115 (STANLEY R & D) and the upper end of the display unit 114 (7-segment display unit of two digits) is 2.5 mm.

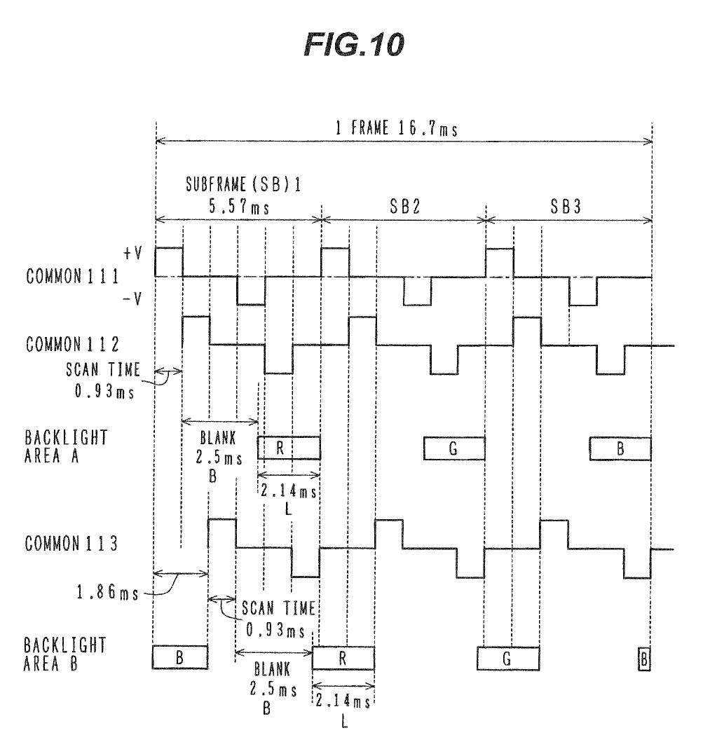

FIG. 10 is a timing chart showing timings of drive waveforms of the common electrodes 111 to 113 and backlight emission in the display areas A and B, respectively of the liquid crystal display device of the second embodiment. One frame was set to 16.7 ms and divided at an equal pitch into three subframes SB1 to SB3 of 5.57 ms for RGB emission. A drive frequency of multiplex driving waveforms to be applied to the liquid crystal display unit was set to about 180 Hz. A scan time per common electrode is about 0.93 ms. A blank time B was set to 2.5 ms. The display areas A and B are scanned in this order.

Two common electrodes 111 and 112 belong to the display area A. After a scan time of 0.93 ms of the common electrode (after the scan standby time of 0.93 ms required to scan common electrodes corresponding in number to the total number of common electrodes in the display area A subtracted by “1”) after the start time when a drive waveform starts being applied to the common electrode 111 to be scanned first, i.e., after the start time of the subframe, a drive waveform starts being applied to the common electrode 112 to be scanned second (last in the display area A).

In the display area A, a blank time B is set from the start time when the drive waveform is applied to the common electrode 112 last scanned in the display area A, and a backlight emission time L is set after the blank time B to the end time of the subframe. The backlight emission time L is about 2.14 ms.

A drive sequence for the display area B is set as that for the display area A shifted by a scan time of about 1.86 ms for two common electrodes in the display area.

The display area B has only one common electrode 113. However, after a scan time of 0.93 ms for one common electrode after the start time when a drive waveform is applied to the common electrode 113, a blank time B is set and a backlight emission time L is set after the blank time B to the end time of the subframe. Also in the display area B, the backlight emission time is about 2.14 ms similar to the display area A.

Similar to the first embodiment, also in the second embodiment, the display screen is divided into a plurality of display areas to reduce the number of common electrodes to be scanned in the subframe so that a long backlight emission time can be retained.

Furthermore, in the second embodiment, the drive sequence in the display area A having a relatively large number of common electrodes is shifted by a predetermined time to use this sequence as that in the display area B having a relatively small number of common electrodes. In this manner, even if the numbers of common electrodes are not equal the emission timings in the subframes are coincident and the backlight emission time becomes equal so that a display luminance can be made uniform.

Visual states were observed by manufacturing the liquid crystal display device under FS driving shown in the timing chart of FIG. 10. An NWTN unit was used as the liquid crystal display unit. It was visually confirmed that a display luminance was uniform in both the display areas A and B having different numbers of common electrodes.

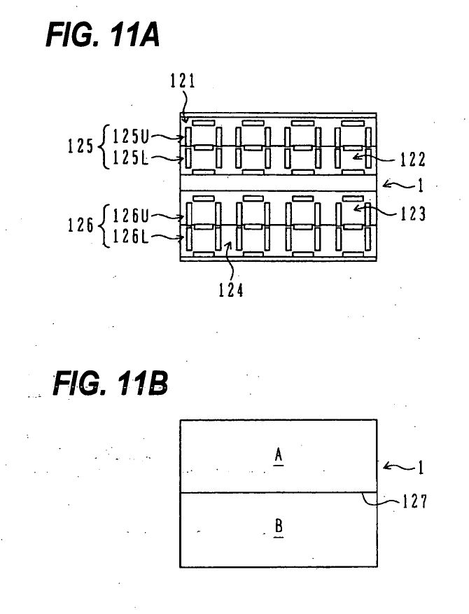

Next, description will be made on the liquid crystal display device of the third embodiment under multiplex driving at a 1/4 duty and a 1/3 bias. FIG. 11A shows a display pattern of a liquid crystal display unit 1. The liquid crystal display unit of the third embodiment has four common electrodes 121 to 124, and 7-segment display units 125 and 126 of four digits are disposed in two rows.

The upper 7-segment display unit 125 of four digits are divided into an upper 3-segment display unit 125U and a lower 4-segment display unit 125L. The lower 7-segment display unit 126 is divided into an upper 3-segment display unit 126U and a lower 4-segment display unit 126L. Segment electrodes of the display units 125U, 125L, 126U and 126L face the common electrodes 121, 122, 123 and 124, respectively.

FIG. 11B shows a display area. The display screen is divided into two display areas A and B. The display area A is inclusive of the display units 125U and 125L, i.e., the upper 7-segment display unit 125 of four digits and has a shape defined approximately by the outer contour of a set of the common electrodes 121 and 122. The display area B is inclusive of the character display units 126U and 126L and has a shape defined approximately by the outer contour of a set of the common electrodes 123 and 124.

A border 127 between the display areas A and B is defined at the center of the line space between the upper 7-segment display unit 125 of four digits and the lower 7-segment display unit 126 of four digits. The line space between the upper 7-segment display unit 125 of four digits and the lower 7-segment display unit 126 of four digits is 2.5 mm.

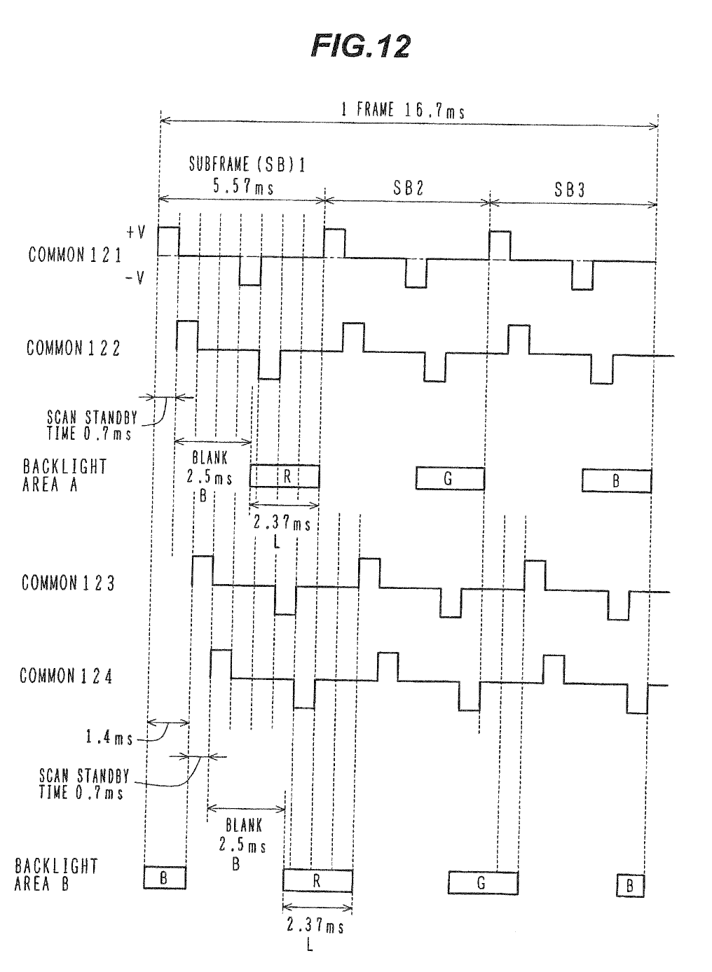

FIG. 12 is a timing chart showing timings of drive waveforms of the common electrodes 121 to 124 and backlight emission in the display areas A and B, respectively of the liquid crystal display device of the third embodiment. One frame was set to 16.7 ms and divided at an equal pitch into three subframes SB1 to SB3 of 5.57 ms for RGB emission. A drive frequency of multiplex driving waveforms to be applied to the liquid crystal display unit was set to about 180 Hz. A scan time per common electrode is about 0.7 ms. A blank time B was set to 2.5 ms. The display areas A and B are scanned in this order.

Similar to the display area A of the second embodiment, two common electrodes 121 and 122 belong to the display area A. A blank time B is set from the start time when a drive waveform is applied to the common electrode 122 to be scanned last, and a backlight emission time L is set after the blank time B to the end time of the subframe. The backlight emission time is about 2.37 ms.

Similar to the display area A, the display area B of the third embodiment has also two common electrodes 123 and 124. An operation sequence of the display area B is set to the drive sequence of the display area A shifted by about 1.4 ms which is a scan time of two common electrodes of the display area A.

Namely, after a scan time of 0.7 ms of the common electrode 123 of the display area, a drive waveform starts being applied to the second (last) common electrode 124 of the display area B, a blank time B is set from the start time when a drive waveform is applied to the common electrode 124, and a backlight emission time L is set until the end time of the subframe. Similar to the display area A, also in the display area B, a backlight emission time L is about 2.37 ms. Since the backlight emission time is equal for both the display areas A and B, a uniform display luminance can be obtained.

As compared to the backlight emission time of 0.99 ms obtained by the conventional driving method not dividing the display screen into a plurality of display areas described with reference to FIG. 23, the emission time is prolonged by about 1.4 ms. It is therefore considered that the display luminance can be improved considerably.

Visual states were observed by manufacturing the liquid crystal display device under FS driving of the third embodiment shown in the timing chart of FIG. 12 and a conventional liquid crystal display device under FS driving shown in the timing chart of FIG. 23. At NWTN unit was used as the liquid crystal display unit. Although color purity was similar for both the embodiment and conventional units, it was confirmed that a display luminance of the embodiment was improved definitely.

In the third embodiment (also in the sixth embodiment to be described later), although two common electrodes are assigned to each of the display areas A and B, common electrodes different in number may be assigned to each display area similar to the second embodiment. For example, three common electrodes 121 to 123 may be assigned to the display area A, and the remaining one common electrode 124 is assigned to the display area B.

In this case, however, in order to have the same display luminance for both the display areas A and B, it is preferable as described in the second embodiment that a drive sequence is adopted which makes a scan standby time of the display area B having a relatively small number of common electrodes be equal to a scan standby time of the display area A having a relatively large number of common electrodes.

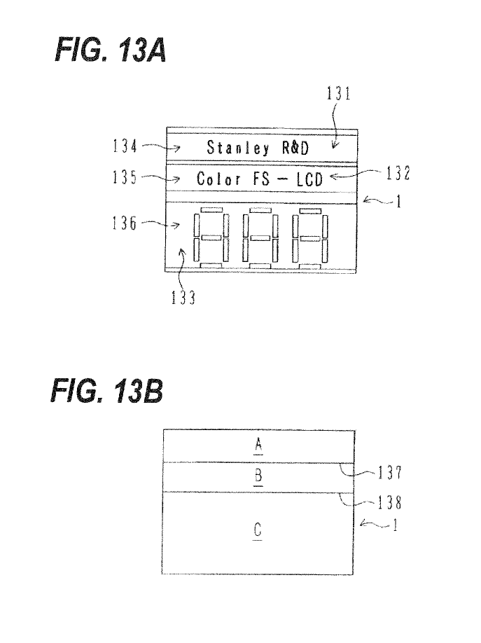

Next, description will be made on the liquid crystal display device of the fourth embodiment under multiplex driving at a 1/3 duty and a 1/3 bias. FIG. 13A shows a display pattern of a liquid crystal display unit 1. The liquid crystal display unit of the fourth embodiment has three common electrodes 131 to 133, a 1-segment display unit 134 for displaying a character string of “Stanley R & D”, a 1-segment display unit 135 for displaying a character string of “Color FS-LCD”, and a 7-segment display unit 136 of three digits. Segment electrodes of the display units 134, 135 and 136 face the common electrodes 131, 132 and 133, respectively.

FIG. 13B shows a display area. The display screen is divided into three display areas A to C. The display areas A to C are inclusive of the display units 134 to 136, and have shapes defined approximately by the outer contours of the common electrodes 131 to 133, respectively.

A border 137 between the display areas A and B and a border 138 between the display areas B and C are defined at the center of the line space between the display units 134 and 135 and at the center of the line space between the display unit 135 and 136, respectively. A line space between the display units 134 and 135 and a line space between the display units 135 and 136 are both 2.5 mm.

The backlight has three multicolor light sources for illuminating the display areas A to C and the light distribution structure not mixing illumination light beams in the display areas A to C.

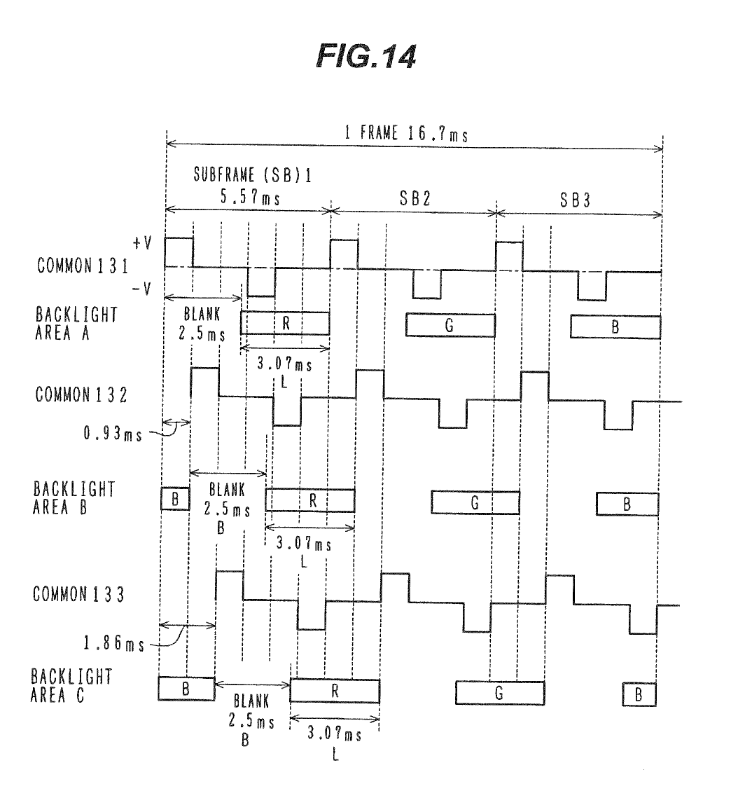

FIG. 14 is a timing chart showing timings of drive waveforms of the common electrodes 131 to 133 and backlight emission in the display areas A to C, respectively of the liquid crystal display device of the fourth embodiment. One frame was set to 16.7 ms and divided at an equal pitch into three subframes SB1 to SB3 of 5.57 ms for RGB emission. A drive frequency of multiplex driving waveforms to be applied to the liquid crystal display unit was set to about 180 Hz. A scan time per common electrode is about 0.93 ms. A blank time B was set to 2.5 ms. The display areas A to C are scanned in this order.

Since one common electrode 131 belongs to the display area A, in the display area A, a blank time B can be set from the subframe start time without a scan standby time, and a backlight emission time L is set after the blank time B to the end time of the subframe. The backlight emission time is about 3.07 ms.

Since one common electrode 132 and one common electrode 133 belong to the display areas B and C, respectively, a drive sequence of the display area B is set to that of the display area A shifted by about 0.93 ms which is a scan time for one common electrode of the display area A, and a drive sequence of the display area C is set to that of the display area A shifted by about 1.86 ms which is a total scan time for two common electrodes of the display areas A and B. Backlight emission times L of the display areas B and C are also about 3.07 ms. Since the backlight emission time is the same for all display areas A to C, a display luminance can be made uniform.

Visual states were observed by manufacturing the liquid crystal display device under FS driving shown in the timing chart of FIG. 14. The same emission luminance of the backlight is used for each of the display areas A to C. It was observed that a display luminance was uniform for the display areas A to C.

In the first to fourth embodiments, description has been made on the liquid crystal display devices under multiplex driving conditions at the 1/2 duty to 1/4 duty, with the backlight display screen being divided into three areas at a maximum. It can be considered that the liquid crystal display device can be operated up to a duty number of 8 (1/8 duty). However, as described above, a shortest distance between display units in adjacent display areas (a shortest distance between display pixels) is set preferably not shorter than 1 mm or more preferably not shorter than 2 mm.

In a display unit set with a duty number larger than 8, a dot matrix display unit becomes important. However, this unit is not realistic because it becomes difficult to retain a distance between display units and to make position alignment of a separation portion between a liquid crystal display unit and a backlight. In order to prevent a complicated structure, it can be considered that the number of display areas is set not larger than 4.

A scan standby time SM is 0 at Cmax=1, and (Cmax−(M−1))/(2f×N) in other cases, wherein S is a one subframe time, N (1/N duty driving) is the number of common electrodes of a liquid crystal display unit, f is a drive frequency of the liquid crystal display unit, M is the number of display areas, and Cmax is the maximum number of common electrodes belonging to a display area.

By representing the numbers of common electrodes of a display area (hereinafter called a current display area) and of a display area to be scanned immediately thereafter (hereinafter called a next display area) by Cb and Ca, respectively, although the operation sequences of the current and next display areas are the same, the operation timing of the next display area is lagged by (Cb+(Ca−1))/(2f×N) from the current display area.

As in the above-described embodiments, the common electrode shape is often a rectangular shape elongated along the right/left direction of a liquid crystal display unit. However, the common electrode shape may take a modified shape such as an L-character shape depending upon a display pattern. In thus case, a display area defined approximately along the contour of a common electrode has also a modified shape not a rectangular shape elongated along the right/left direction of the liquid crystal display unit.

Next, description will be made on the electrooptical response characteristics at a room temperature of three types of liquid crystal display units of an NWTN mode, a two-layer TN mode and a VA mode manufactured in the manner described previously Measurements were conducted by using LCD5200 manufactured by Otsuka Electronics Co., Ltd.

The drive conditions will be described. The drive waveform is a rectangular waveform for static driving (1/1 during driving), and a multiplex driving waveform at a 1/2 bias for 1/2 duty driving and a 1/3 bias for 1/3 and 1/4 duty driving. A drive frequency was set to 500 Hz. A drive voltage VLCD under respective drive conditions was adjusted to obtain the best visual display state. An off-voltage in static driving was all set to 0 V.

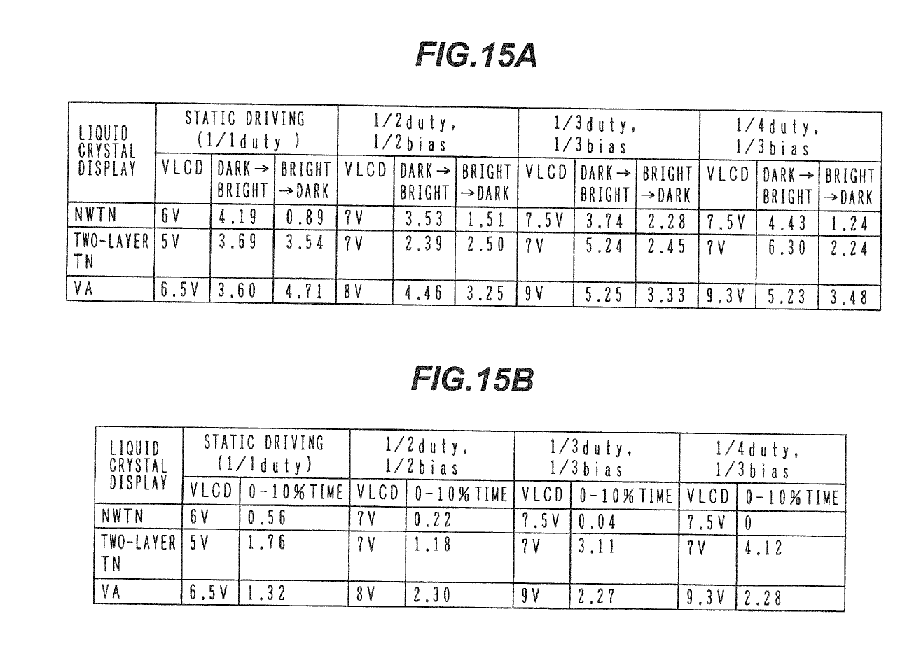

FIG. 15A is a table showing a list of an on-voltage drive voltage VLCD, a rise response time (dark to bright) and a fall response time (bright to dark) of each of an NWTN unit, a two-layer TN unit and a VA unit, respectively during static driving and multiplex driving at a 1/2 to 1/4 duty. A rise response time and fall response time are represented in the unit of ms.

A relative transmittivity is incorporated having a transmittivity of 0% in the steady state upon application of a dark display voltage and a transmittivity of 100% in the steady state upon application of a bright display voltage. A rise response time from dark display to bright display is defined as a time taken for the relative transmittivity to rise from 0% to 90%, and a fall response time from bright display to dark display is defined as a time for the relative transmittivity to fall from 100% to 10%.

Although a response time depends on settings of the drive voltage VLCD, there is a tendency that the rise response time prolongs as a duty become large, particularly for the two-layer TN unit and VA unit. There also appears a tendency that a response time is shortened as the drive voltage VLCD is made high, for the fall response of the two-layer TN unit and VA unit.

It can be considered from comparison between the NWTN unit and the normally black type two-layer TN unit and VA unit that there is a tendency that the normally black type unit has a longer fall response time than that of the NWTN unit.

FIG. 15B is a table showing a list of an on-voltage drive voltage VLCD and a rise response lag time (0 to 10% time) of each of an NWTN unit, a two-layer TN unit and a VA unit, respectively during static driving and multiplex driving at a1/2 to 1/4 duty. A rise response lag time is represented in the unit of ms. The rise response lag time is defined as a time for the relative transmittivity to rise from 0% to 10%.

There is a tendency that the rise response lag time shortens as the duty becomes large, for the NWTN unit. There is a tendency that the rise response lag time of the two-layer TN unit prolongs as the duty becomes large. The rise response lag time of the VA unit has less dependency upon the duty. There is however a tendency that the rise response lag time prolongs during driving at a 1/2 to 1/4 duty more than during static driving.

It can be considered from comparison between the NWTN unit and the normally black type two-layer TN unit and VA unit that there is a tendency that the normally black type unit has a longer rise response lag time than that of the NWTN unit.

As the fall response time prolongs, it is necessary that the blank time in the subframe is set longer in order to avoid color purity from being lowered. However, as the blank time becomes long, the backlight emission time shortens, leaving a fear of a lowered display luminance.

As described above, although the normally black type unit is suitable for use with a liquid crystal display device having an improved display quality, there is a tendency that the fall response time becomes long as compared to that of the normally white type unit so that it becomes relatively difficult to retain a long backlight emission time. An FS driving method has been long desired which can obtain a long backlight emission time even if the method is used for the normally black type unit.

Next, the FS driving method of this kind will be studied. A display unit of bright display in one subframe (hereinafter called a first subframe) is maintained to have bright display or changed to dark display in the next subframe (hereinafter called a second subframe). Even if the bright display is switched to the dark display, a transmittivity will not be lowered instantaneously as shown in FIG. 15A and FIG. 19. Even if dark display is switched to bright display of the display unit in the second subframe, a transmittivity will not be increased instantaneously as shown in FIGS. 15A and 15B.

If emission color of the backlight corresponding to the display pattern of the first subframe is continued to be turned on during an initial period of the second subframe in the rise response lag time (in the time until the transmittivity reaches 10%) shown in FIG. 15B, it can be considered that color purity can be suppressed from being lowered by light leak of the emission color into the display unit switched to bright display in the second subframe, and that a luminance of the display unit corresponding to the display pattern of the first subframe can be improved.

Namely, the backlight of emission color corresponding to the display pattern of the first subframe is turned on in the first subframe and made to be continuously turned on in the initial period of the second subframe following immediately after the first subframe. It can be considered that a long backlight emission time can be retained and a display luminance can be improved while the color purity is suppressed from being lowered.

As described with reference to FIGS. 15A and 15B, the normally black type unit (two-layer TN unit and VA unit) has a relatively long rise response lag time so that a longer prolonged emission time can be retained. Further, since a fall response time is relatively long, the display unit switching from bright display to dark display has a relatively high transmittivity during the prolonged emission time. From this viewpoint, the FS driving method of prolonging the backlight emission time to the initial period of the next subframe is effective for improving a display luminance of a liquid crystal display using a normally black type unit.

In a display unit switching from bright display to bright display by the normal FS driving method, an emission time prolongs while the bright display is maintained, and high luminance improvement can be expected.

Next, the FS driving method according to the fifth embodiment will be described. Used is a liquid crystal display device under multiplex driving at a 1/2 duty and a 1/2 bias described in the first embodiment with reference to FIG. 5A. Namely, the liquid crystal device uses one common electrode 101 and one common electrode 102 for two display areas A and B respectively. As the liquid crystal display unit, a normally black type two-layer TN unit is used.

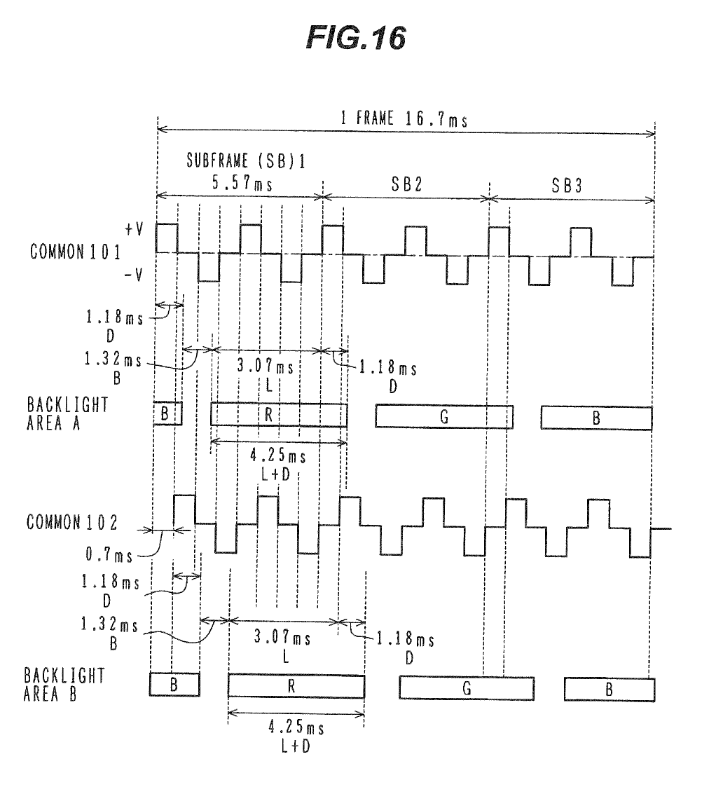

FIG. 16 is a timing chart showing timings of drive waveforms of the common electrodes 101 and 102 and backlight emission in the display areas A and B, respectively of a liquid crystal display device. Similar to the first embodiment (FIG. 8), one frame was set to 16.7 ms and divided at an equal pitch into three subframes SB1 to SB3 of 5.57 ms for RGB emission, a drive frequency was set to about 360 Hz, and a scan time per common electrode was set to about 0.7 ms. Also similar to the first embodiment, a drive sequence of the display area B is set to the drive sequence of the display area A shifted by a scan time per common electrode of 0.7 ms.

A current subframe backlight time L for turning on the backlight of emission color corresponding to the display pattern of the subframe is set after about 2.5 ms (refer to the 1/2 duty driving shown in FIG. 15A) for awaiting a fall response completion of the two-layer TN unit after the start time of the subframe to the end time of the subframe. The current subframe backlight emission time L is about 3.07 ms. This backlight emission time is the same as that by the driving method similar to that of the first embodiment.

In the fifth embodiment, a preceding subframe backlight emission time D is set starting from the start time of the subframe by prolonging the turn-on of the backlight of emission color corresponding to the display pattern of the subframe immediately before. The preceding subframe backlight emission time D is set to a rise response lag time of 1.18 ms (refer to the 1/2 duty driving shown in FIG. 15B) of the two-layer TN unit.

A blank time B for turning off the back light is 1.32 ms which is 2.5 ms for awaiting a fall response completion (corresponding to the blank time B of the first embodiment), subtracted by the preceding subframe backlight emission time of 1.18 ms.

The backlight emission time per one color is about 4.25 ms prolonged by 1.18 ms from 3.07 ms, because the preceding subframe backlight emission time is incorporated. By prolonging the backlight emission time, a display luminance can be improved.

Visual states were compared between the liquid crystal display device using a two-layer TN unit driven by the method of the fifth embodiment shown in the timing chart of FIG. 16 and the device driven by the method similar to the first embodiment shown in the timing chart of FIG. 8 (the driving method not incorporating the preceding subframe backlight emission time). It was confirmed that although there was hardly a difference of color purity between both the embodiments, a display luminance of the fifth embodiment was improved definitely.

Next, the FS driving method according to the sixth embodiment will be described. Used is a liquid crystal display device under multiplex driving at a 1/4 duty and a 1/3 bias described in the third embodiment with reference to FIG. 11A. Namely, the liquid crystal device uses two common electrodes 121 and 122 and two common electrodes 123 and 124 for two display areas A and B, respectively. As the liquid crystal display unit, a normally black type two-layer TN unit is used.

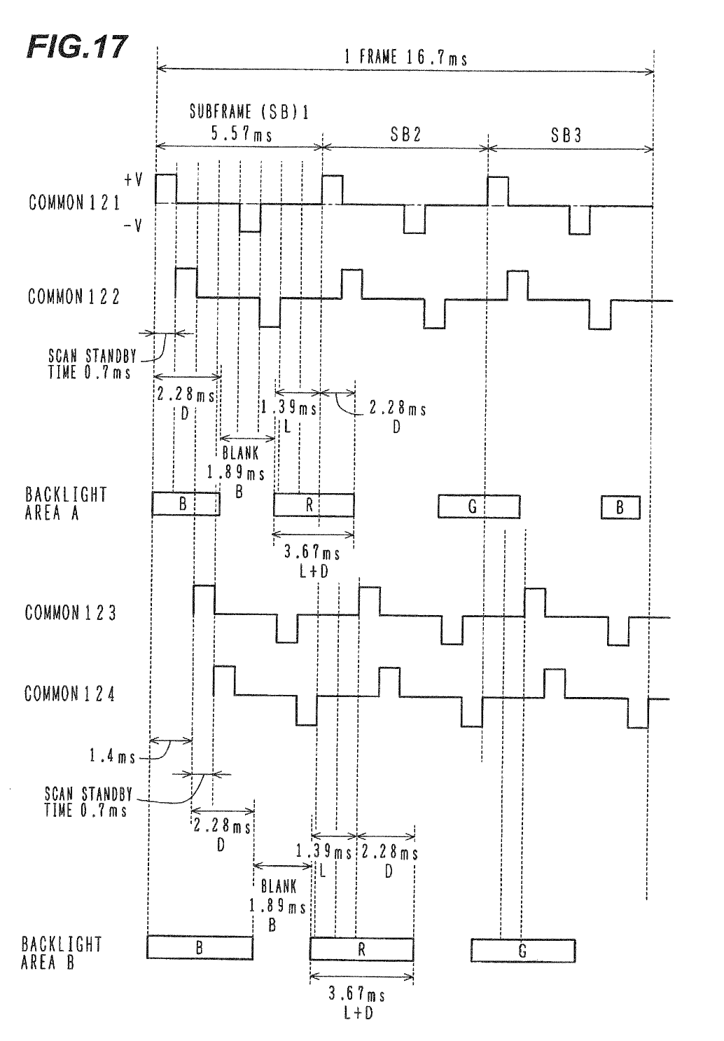

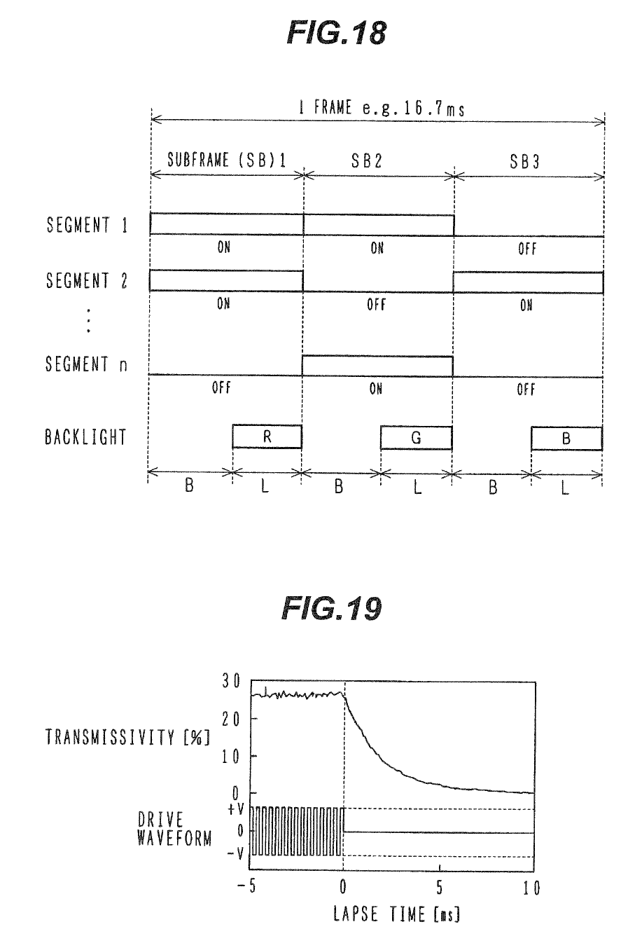

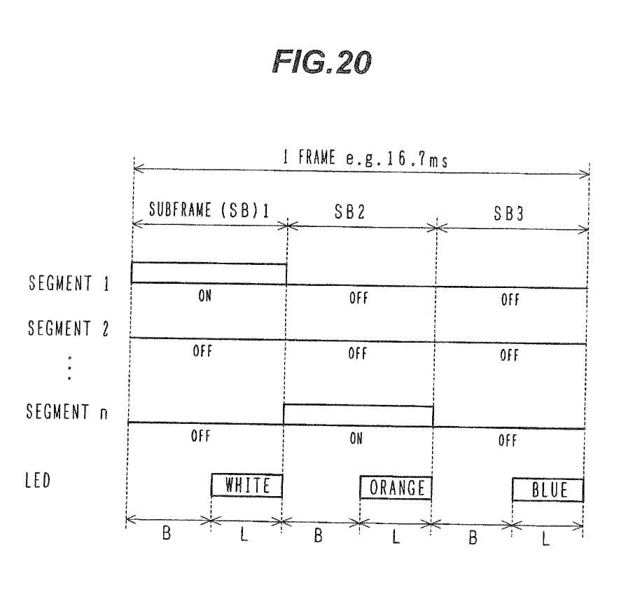

FIG. 17 is a timing chart showing timings of drive waveforms of the common electrodes 121 and 124 and backlight emission in the display areas A and B. Similar to the third embodiment (FIG. 12), one frame was set to 16.7 ms and divided at an equal pitch into three subframes SB1 to SB3 of 5.57 ms for RGB emission, a drive frequency was set to about 180 Hz, and a scan time per common electrode was set to about 0.7 ms. Also similar to the third embodiment, a drive sequence of the display area B is set to the drive sequence of the display area A shifted by a scan time per two common electrodes of 1.4 ms.

A current subframe backlight time L for turning on the backlight of emission color corresponding to the display pattern of the subframe is set to a period after a scan time of 0.7 ms per common electrode from the start time of the subframe and after a fall response time of the VA unit of about 3.48 ms (refer to the 1/4 duty driving in FIG. 15A), to the end time of the subframe. The current subframe backlight emission time L is about 1.39 ms.

In the sixth embodiment, a preceding subframe backlight emission time D is set starting from the start time of the subframe by prolonging the turn-on of the backlight of emission color corresponding to the display pattern of the subframe immediately before. The preceding subframe backlight emission time D is set to a rise response lag time of 2.28 ms (refer to the 1/4 duty driving shown in FIG. 15B) of the VA unit.

A blank time B is about 1.89 ms which is 4.17 ms (0.7 ms for scan standby time +3.48 ms for awaiting a fall response completion) subtracted by the preceding subframe backlight emission time of 2.28 ms.

The backlight emission time per one color is about 3.67 ms prolonged by 2.28 ms from 1.39 ms, because the preceding subframe backlight emission time is incorporated. By prolonging the backlight emission time, a display luminance can be improved.

Visual states were compared between the liquid crystal display device using a VA unit driven by the method of the sixth embodiment shown in the timing chart of FIG. 17 and the device driven by the method similar to the third embodiment shown in the timing chart of FIG. 12 (the driving method not incorporating the preceding subframe backlight emission time). It was confirmed that although there was hardly a difference of color purity between both the embodiments, a display luminance of the sixth was improved definitely.

One subframe time S is divided into the preceding subframe backlight emission time D, blank time B and current subframe backlight emission time L. Namely, S=D+B+L.

In the subframe, awaiting a fall response time, the current subframe backlight emission time L is set for turning on the emission color corresponding to the subframe. However, if the fall response time becomes very long due to a low temperature or the like, the fall response completion may reach the end time of the subframe. In this case, the current subframe backlight emission time L is 0.

However, if the backlight of this emission color is turned on during the initial stage of the next subframe, the emission time can be retained. Namely, even if the current subframe backlight emission time L is 0, the preceding subframe backlight emission time D is set not to 0, the emission time can be retained.

The FS driving method incorporating the preceding subframe backlight emission time can be applied to the case in which the backlight of emission color corresponding to the display pattern of a subframe is not turned on during the subframe, but it is turned on during the subframe immediately thereafter.

With the FS driving method incorporating the preceding subframe backlight emission time, even if the current subframe backlight emission time L is not 0 or is 0, the backlight of emission color corresponding to the display pattern of the subframe is turned on during a period from some time point in the subframe to some time point in the subframe immediately thereafter.

As described above, a scan standby time SM is 0 at Cmax=1 and (Cmax−(M−1))/(2f×N) in other cases wherein S is a one subframe time, N (1/N duty driving) is the number of common electrodes of a liquid crystal display unit, f is a drive frequency of the liquid crystal display unit, M is the number of display areas, and Cmax is the maximum number of common electrodes belonging to a display area.

A sum of the preceding subframe backlight emission time D and blank time B is preferably not shorter than a sum of the scan standby time SM and liquid crystal display unit fall response time.

In the liquid crystal display devices of the first to sixth embodiments, the display screen is divided into display areas for one or more common electrodes, and the multiplex FD driving is performed. It is therefore possible to reduce the number of common electrodes to be scanned in each subframe and shorten a scan standby time so that it is possible to retain a long backlight emission time and improve a display luminance.

In the embodiments described above, although the backlight of emission colors is turned on in the frame in the order of R, G and B, the order of emission colors may be changed in the display areas because a difference in visual states will not appear. For example, color emission may be performed in the order of R, G and B in the display area A, and in the order of G, B and R in the display area B. It is however necessary to properly set a bright/dark display pattern in each subframe in accordance with the order of emission colors. Further, although primary colors of R, G and B are used as backlight emission colors, other emission colors may also be used.

Although the normal FS driving liquid crystal display device has been described by way of example in the embodiments, a color break-less FS driving liquid crystal display device may also be used. In the color break-less FS driving, although bright display in each display unit is performed only in one subframe of one frame, desired color display can be performed through color mixture display by turning on a light source of a plurality of colors at the same time. In the color break-less FS driving, by changing emission color in each display area during one frame, the number of simultaneous emission colors in the display screen can be increased.

In the above-described embodiment, although one frame is divided into three subframes, the number of subframes, two or more subframes, may be selected in accordance with a necessary display style. If necessary, the frame may be divided at different pitches. One frame period may be changed for each one frame display, and the subframe period is changed correspondingly.

The liquid crystal display devices and FS driving methods of the first to sixth embodiments may be applied to the following products. The products include a vehicle mounted information display device having a segment display unit or a segment display unit and a dot matrix display unit, a display unit for car audio, and an operation panel display unit of a business machine such as a copy machine.

Next, description will be made on liquid crystal display devices according to the seventh to tenth embodiments.

In the color break-less FS driving, (M+1) colors (emission colors and black) can be displayed in one frame. If the number of display colors is desired to be increased in the same frame, it is necessary to increase the number M of subframes. However, as the number M of subframes increases, a time assigned to each subframe in one frame period is shortened so that a display luminance of the display device lowers or there is a fear of a lowered color purity because of an insufficient blank time.

A backlight emission color may be changed in each fame. For example, 2×M+1 colors can be displayed in two frames. This provides similar effects of setting low a substantial frame frequency. Depending upon frame frequency settings, flicker may appear in the display.

As the number of subframes is reduced, display flicker can be suppressed and a display luminance and color purity can be improved. A relatively good display state can be obtained even if a response speed of the liquid crystal display unit is relatively low. However, if the number of subframes is small, the number of display colors in one frame reduces and the degree of display freedom is degraded.

It has been long desired to provide techniques capable of improving a display luminance and increasing the number of display colors of a liquid crystal display device under color break-less FS driving.

With reference again to FIG. 1, description will be made on the common structure to color break-less FS driving liquid crystal display devices according to the seventh to tenth embodiments.

Each of liquid crystal display units 1 of the seventh to tenth embodiments has at least one common electrode and a plurality of groups of segment electrodes for segment display facing the common electrode(s). A display screen is divided into display areas A, B and the like for each group of segment electrodes.

The backlight 2 can perform multicolor emission similar to the first to sixth embodiments.

The drive unit 3 synchronously drives the liquid crystal display unit 1 and each multicolor light source LS at desired timings to perform color break-less IFS driving. In the color break-less FS driving bright display is performed only in one subframe of the frame in each segment display unit. Desired color display not only primary color display but also color mixture display turning on the light source of a plurality of colors at the same time can be performed in each subframe.

The liquid crystal display unit 1 may use, for example, an NWTN mode liquid crystal display unit (refer to FIGS. 2A to 2C and corresponding description), a two-layer TN mode liquid crystal display unit (refer to FIG. 3 and corresponding description) and a VA mode liquid crystal display unit (refer to FIG. 4 and corresponding description).

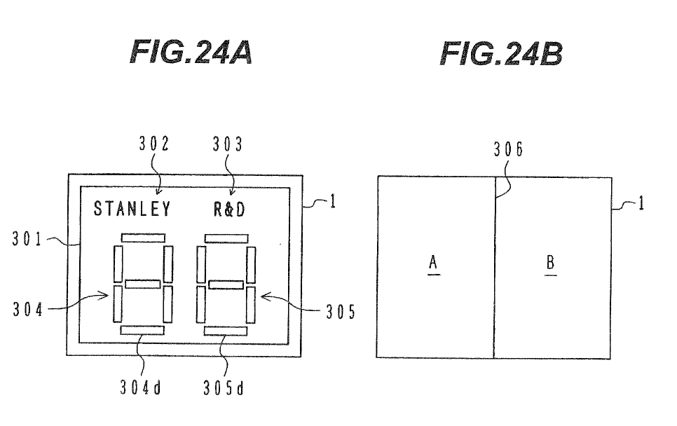

Next, the liquid crystal display device of the seventh embodiment will be described. In the seventh embodiment, the liquid crystal display unit is an NWTN unit having a non-display area being light shielded with a metal black mask and patterned wirings for static driving. The drive unit performs static driving. FIG. 24A shows a display pattern of the liquid crystal display unit 1.

The liquid crystal display unit 1 has one common electrode 301, a 1-segment display unit 302 for displaying a character string of “STANLEY”, a 1-segment display unit 303 for displaying a character string of “R & D”, and a 7-segment display unit of two digits (a 7-segment display unit 304 for left digit and a 7-segment display unit 305 for right digit). Segment electrodes of all display units 302 to 305 face the common electrode 301. Each display unit and the segment electrodes for the display unit are represented by the same reference numeral when necessary.

In the liquid crystal display device of the seventh embodiment, the base is black/white display, and color display is performed partially. The background is black display. The character display unit 302 of “STANLEY” is orange display, the character display unit 303 of “R & D” is white display, the left 7-segment display unit 304 is white display, and the right 7-segment display unit 305 is blue display.

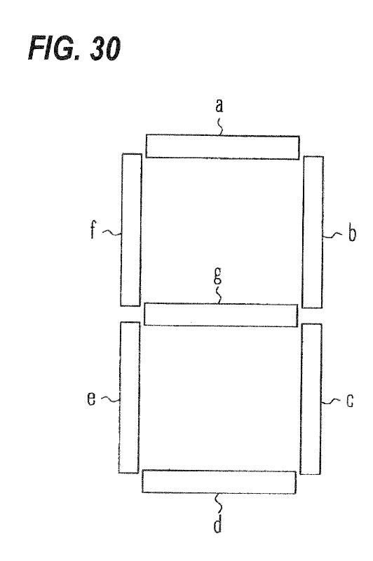

As shown in FIG. 30, in order to distinguish between segments constituting the 7-segment display unit, an uppermost horizontal bar is represented by an alphabet a, an upper right vertical bar is represented by an alphabet b, a lower right vertical bar is represented by an alphabet c, a lower most horizontal bar is represented by an alphabet d, a lower left vertical bar is represented by an alphabet e, an upper left vertical bar is represented by an alphabet f and a center horizontal bar is represented by an alphabet g.

FIG. 24B shows display areas of the liquid crystal display device of the seventh embodiment. The display screen is divided into two display areas A and B. The display area A is set being inclusive of a group constituted of the character display unit 302 of “STANLEY” and the left 7-segment display unit 304, and the display area B is set being inclusive of a group constituted on the character display unit 303 of “R & D” and the right 7-segment display unit 305. A border 306 between the display areas A and B is disposed at the center between the right edge of the left 7-segment display unit 304 and the left edge of the right 7-segment display unit 305.

The backlight may be the side light type described with reference to FIG. 6 or the just-under type described with reference to FIG. 7.

In order for the segment display unit in the display area A and the segment display unit in the display area B to be illuminated separately with the multicolor light sources LSA and LSB, it is preferable that a distance between the segment display units is sufficiently long. A shortest distance between the segment display units included in adjacent display areas (a shortest distance between display pixels) is preferably not shorter than 1 mm, or more preferably not shorter than 2 mm. In this embodiment, a distance between the right edge of the left 7-segment display unit 304 and the left edge of the right 7-segment display unit 305 is set to 2.5 mm.

Next, consideration will be made on a liquid crystal display device whose display screen is not divided into a plurality of display areas, as a comparative example. In the liquid crystal display device of the comparative example, the whole display pattern shown in FIG. 24A is displayed by using a backlight having one multicolor light source.

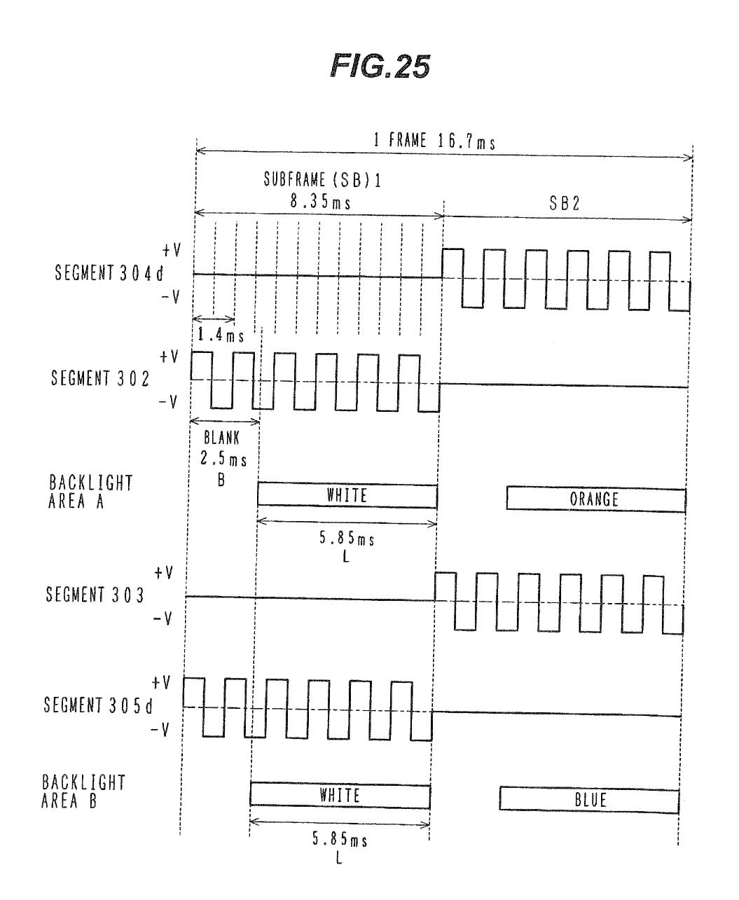

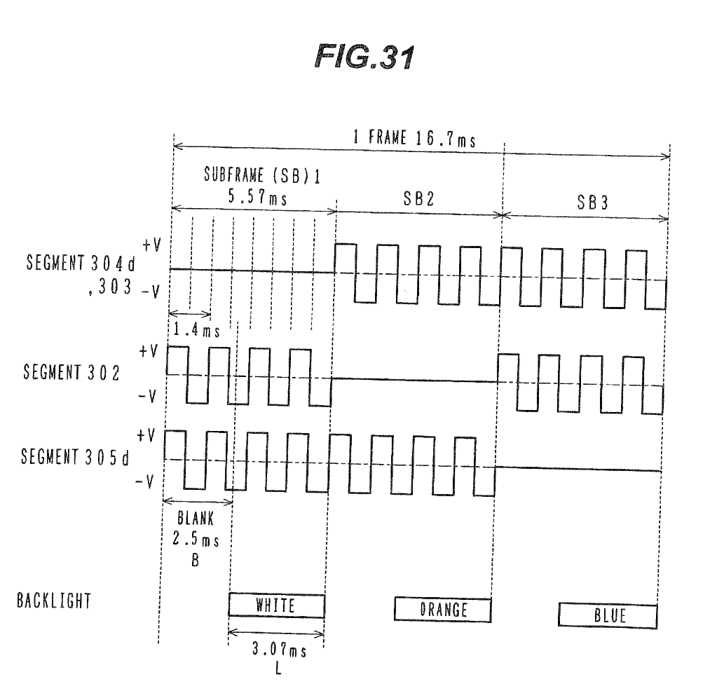

Next, description will be made on the FS driving method for the liquid crystal display devices of the seventh embodiment and the comparative example. FIG. 25 is a timing chart showing timings of drive voltages applied across the common electrode 301 and the segment electrodes 302, 303, 304d and 305d and emission of the backlight in the display areas A and B, respectively of the liquid crystal display device of the seventh embodiment. FIG. 31 is a timing chart showing timings of drive voltages applied across the common electrode and segment electrodes 302, 303, 304d and 305d and emission of the backlight, respectively of the liquid crystal display device of the comparative example. The lowermost segments 304d and 305d are used as representative segments of both the left and right 7-segment display units 304 and 305.

In the embodiment and comparative example, one frame was set to about 16.7 ms, subframes were set at an equal pitch, and a blank time B was set to about 2.5 ms. A backlight emission time L is a period after the blank time B from the start time of the subframe to the end time of the subframe. A drive waveform applied to each segment was a rectangular wave, a drive voltage was set to V=6 V rms, and a drive frequency was set to about 720 Hz. A normally white type is assumed for the liquid display unit for both the embodiment and comparative example.

First, the timing chart (FIG. 31) of the comparative example will be described. The segment display units 302, 303, 304d and 305d are orange display, white display, white display and blue display, respectively. It is therefore necessary to display three emission colors of orange, white, blue in one frame, and the number of subframes is “3”.

In this example, white display is performed for the segment display units 303 and 304d in a first subframe SB1, orange display is performed for the segment display unit 302 in a second subframe SB2, and blue display is performed for the segment display unit 305d in a third subframe SB3.

Each subframe time is about 5.57 ms obtained through equal division of one frame period of 16.7 ms by 3. Since the subframe time is set to 5.57 ms, the blank time of 2.5 ms is subtracted from the subframe time to obtain a backlight emission time of about 3.07 ms in each subframe.

Next, the timing chart (FIG. 25) of the seventh embodiment will be described. In the seventh embodiment, the color break-less FS driving for the display areas A and B is performed in parallel in the same frame. Since emission color in the frame can be made different in the display areas A and B, the number of subframes can be reduced more than that of the comparative example.

Necessary display colors can be obtained at a subframe number of “2”. In this example, in the display area A, white display is performed for the segment display unit 304d in a first subframe SB1, and orange display is performed for the segment display unit 302 in a second subframe SB2. In the display area B, white display is performed for the segment display unit 303 in the first subframe SB1, and blue display is performed for the segment display unit 305d in the second subframe SB2.

Each subframe time is about 8.35 ms obtained through equal division of one frame period of 16.7 ms by 2. Since the subframe time is set to 8.35 ms, the blank time of 2.5 ms is subtracted from the subframe time to obtain a backlight emission time of about 5.85 ms in each subframe. As compare to the comparative example backlight emission time of 3.07 ms, the emission time can be prolonged by about 1.9 times and it is expected that the display luminance can be improved considerably. Assuming that an equal display luminance is obtained for both the seventh embodiment and comparative example, a luminance of the backlight of the embodiment can be suppressed lower.

Visual states were observed by manufacturing the liquid crystal display device of the seventh embodiment under FS driving shown in the timing chart of FIG. 25 and the comparative example liquid crystal display device under FS driving shown in the timing chart of FIG. 31. It was confirmed that both the embodiment and comparative example showed the display state as intended and that the embodiment had definitely a considerably high display luminance.

By distributing display areas for each group of the segment display unit and performing FS driving in parallel for a plurality of display areas, display colors larger in number than the subframe number M+1 can be obtained in one frame. Display colors of BV×M+1 are possible where BV is the number of display areas.

In order to obtain display colors same in number as that of the comparative example as in the case of the seventh embodiment, the number of subframes per frame can be reduced, and the subframe time can be prolonged without prolonging the frame period. It is therefore possible to prolong the backlight emission time in each subframe and improve the display luminance. If the same number of subframes as that of the comparative example is used, the number of displayable colors can be increased more than that of the comparative example.

Although the liquid crystal display unit of static driving is assumed in the seventh embodiment, multiplex driving is required for a larger display capacity.

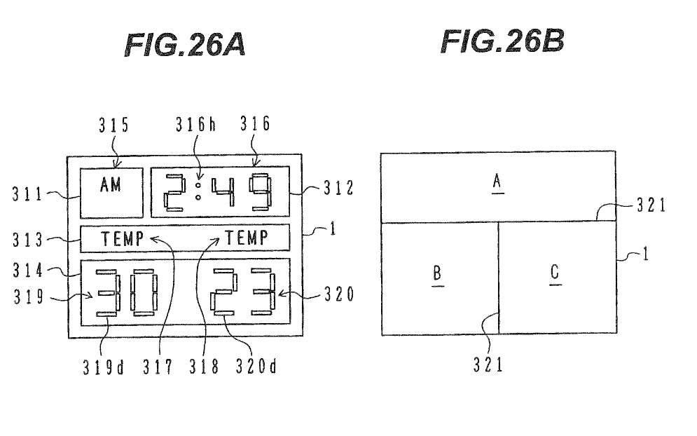

Next, description will be made on the liquid crystal display device of the eighth embodiment under multiplex driving. An NWTN unit is assumed as the liquid crystal display unit, similar to the seventh embodiment. FIG. 26A shows a display pattern of a liquid crystal display unit 1. This example shows a display pattern on the assumption using a clock display and a temperature display in a vehicle interior.

The liquid crystal display unit 1 of the eighth embodiment has: four common electrodes 311 to 314; a 1-segment display unit 315 for displaying a character string “AM”, a display unit 316 for displaying a time constituted of a 7-segment display unit of three digits for displaying hour and minute and a segment display unit 316h for displaying a colon disposed between hour and minute displays; 1-segment display units 317 (left) and 318 (right) for displaying a character string “TEMP”; and 7-segment display units of two digits 319 (left) and 320 (right).

A segment electrode of the display unit 315 faces the common electrode 311, segment electrodes of the display unit 316 face the common electrode 312, segment electrodes of the display units 317 and 318 face the common electrode 313 and segment electrodes of the display units 319 and 320 face the common electrode 314.

Namely, a select voltage is applied to the segment electrode 315 when the common electrode 311 is scanned, to the segment electrodes 316 when the common electrode 312 is scanned, to the segment electrodes 317 and 318 when the common electrode 313 is scanned, and to the segment electrodes 319 and 320 when the common electrode 314 is scanned.

Similar to the seventh embodiment, the background is black display. The character display unit 315 for “AM” is yellow display, the time display unit 316 is white display, the character display units 317 and 318 for two character strings “TEMP” are white display, the left 7-segment display unit of two digits is red display, and the right 7-segment display unit of two digits is blue display.

FIG. 26B shows display areas of the liquid crystal display device of the eighth embodiment. The display screen is divided into three display areas A to C. The display area A is set to be inclusive of a group (i.e., time display unit) constituted of the display units 315 and 316, the display area is set to be inclusive of a group (i.e., left temperature display unit) constituted of the display areas 317 and 319; and the display area C is set to be inclusive of a group (i.e., right temperature display unit) constituted of the display units 318 and 320.

Borders 321 are defined among the display areas, i.e., among the clock display unit, left temperature display unit and right temperature display unit. The shortest distance among the clock display unit, left temperature display unit and right temperature display unit is maintained not shorter than 2.5 mm.

The backlight has a multicolor light source for illuminating each of the display area and a light distribution control structure for making illumination light beams not to be mixed in the display areas A to C.

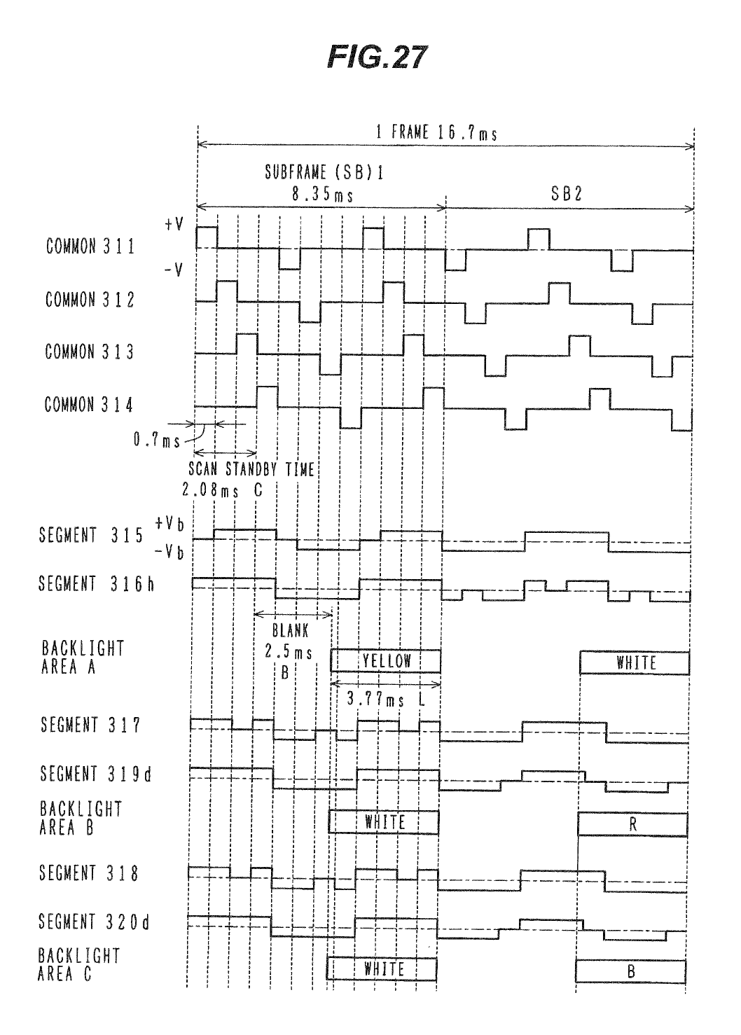

FIG. 27 is a timing chart showing timings of 1/4 duty and 1/3 bias drive waveforms applied to the common electrodes 311 to 314 and segment electrodes 315, 316h, 317, 318, 319d and 320d and emission of the backlight in the display areas A to C according to the eight embodiment.

Used as representative segments are the colon display segment 316h for the time display unit 316, the lowermost segment 319d of the left digit for the 7-segment display unit 319 of two digits of left temperature display, and the lowermost segment 320d of the left digit for the 7-segment display unit 320 of right temperature display.

A common select voltage is set to ±V, and a pixel enters an on-state when ±Vb is applied to the segment. Since the liquid crystal display unit is assumed to be an NWTN unit, the on-state is dark display and the off-state is bright display.

One frame was set to 16.7 ms and divided equally into two subframes. One subframe time is about 8.35 ms. A drive frequency of a multiplex driving waveform applied to the liquid crystal display unit was set to about 180 Hz. A scan time per common electrode is about 0.7 ms.

In this example, in the display area A, yellow display is performed for the segment 315 in a first subframe SB1, and white display is performed for the segment 316h in a second subframe SB2. In the display area B, white display is performed for the segment 317 in the first subframe SB1, and red display is performed for the segment 319d in the second subframe SB2. In the display area C, white display is performed for the segment 318 in the first subframe, and blue display is performed for the segment 320d in the second subframe SB2.

Since there are a plurality of common electrodes as different from static driving, a scan standby time C for awaiting scanning a common electrode becomes necessary in order to make uniform a display luminance of the liquid crystal display unit. More specifically, the scan standby time is represented by C=(N−1)/(f×2N) where N is the number of common electrodes. In this embodiment, the scan standby time is about 2.08 ms.

A backlight emission time L is set to a period after 2.08 ms for the scan standby time of 2.08 ms after the start time of the subframe and after about 2.5 ms for the blank time B, to the end time of the subframe. The backlight emission time L is about 3.77 ms.

Four colors of yellow, white, red and blue are required as emission colors of this embodiment. If the display screen is not divided into a plurality of display areas, i.e., if four emission colors are displayed in one frame, four subframes are required so that a subframe time becomes short and it is not easy to retain a sufficient backlight emission time.

Similar to the seventh embodiment, also in the eighth embodiment, by distributing the segment display units to a plurality of display areas, the number of subframes can be reduced and a backlight emission time can be prolonged by retaining a long subframe time. An improved display luminance can therefore be expected. Visual states were observed by manufacturing the liquid crystal display device under FS driving shown in the timing chart of FIG. 27, and it was confirmed that the display state as intended was obtained.

It is also possible to improve a display luminance by prolonging the backlight emission time to the rise response lag time of a liquid crystal display unit, as in the following ninth and tenth embodiments (refer to the description with reference to FIGS. 15A and 15B and the fifth and sixth embodiments).

First, the FS driving method of the ninth embodiment will be described. A liquid crystal display device used is the liquid crystal display device under static driving described in the seventh embodiment with reference to FIG. 24A. However, a normally black type two-layer TN unit is used as the liquid crystal display unit. Contrary to the seventh embodiment, a bright display state enters during an on-state of a drive voltage, and a dark display state enters during an off-state.

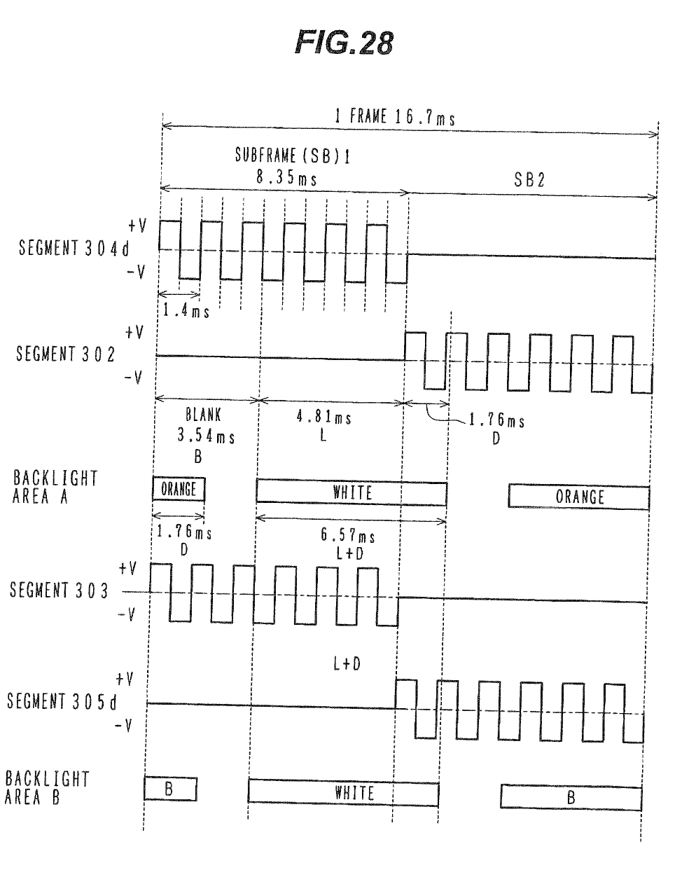

FIG. 28 is a timing chart showing timings of drive voltages applied across the common electrode 301 and the segment electrodes 302, 303, 304d and 305d and emission of the backlight in the display areas A and B. Similar to the seventh embodiment, one frame was set to 16.7 ms and divided at an equal pitch into two subframes SB1 and SB2 of 8.35 ms each. A drive frequency was set to about 720 Hz.

A current subframe backlight time L for turning on the backlight of emission color corresponding to the display pattern of the subframe is set to a period after about 3.54 ms (refer to the static driving shown in FIG. 15A) for awaiting a fall response completion of the two-layer TN unit after the start time of the subframe to the end time of the subframe. The current subframe backlight emission time L is about 4.81 ms.

In the ninth embodiment, a preceding subframe backlight emission time D is set starting from the start time of the subframe by prolonging the turn-on of the backlight of emission color corresponding to the display pattern of the subframe immediately before. The preceding subframe backlight emission time D is set to a rise response lag time of 1.76 ms (refer to the static driving shown in FIG. 15B) of the two-layer TN unit.

The backlight emission time per one color is about 6.57 ms prolonged by 1.76 ms from 4.81 ms, because the preceding subframe backlight emission time is incorporated. By prolonging the backlight emission time, it is expected that a display luminance can be improved.

Visual states were compared between the liquid crystal display device using a two-layer TN unit driven by the method of the ninth embodiment shown in the timing chart of FIG. 28 and the device driven by the method similar to the seventh embodiment shown in the timing chart of FIG. 25 (the driving method not incorporating the preceding subframe backlight emission time). In the driving method not incorporating the preceding subframe backlight emission time similar to the seventh embodiment, since the two-layer TN unit is used, on/off of the drive waveform was reversed from that of the seventh embodiment, and the blank time was set to about 3.5 ms and the backlight emission time was set to about 4.85 ms. Although a display state as intended was obtained for both the devices, it was confirmed that a display luminance of the ninth embodiment was improved definitely.

Next, the FS driving method of the tenth embodiment will be described. A liquid crystal display device used is the liquid crystal display device under multiplex driving at the 1/4 duty described in the eighth embodiment with reference to FIG. 26A. However, a normally black type VA unit is used as the liquid crystal display unit. Contrarily to the eighth embodiment, a bright display state enters during an on-state of a drive voltage, and a dark display state enters during an off-state.

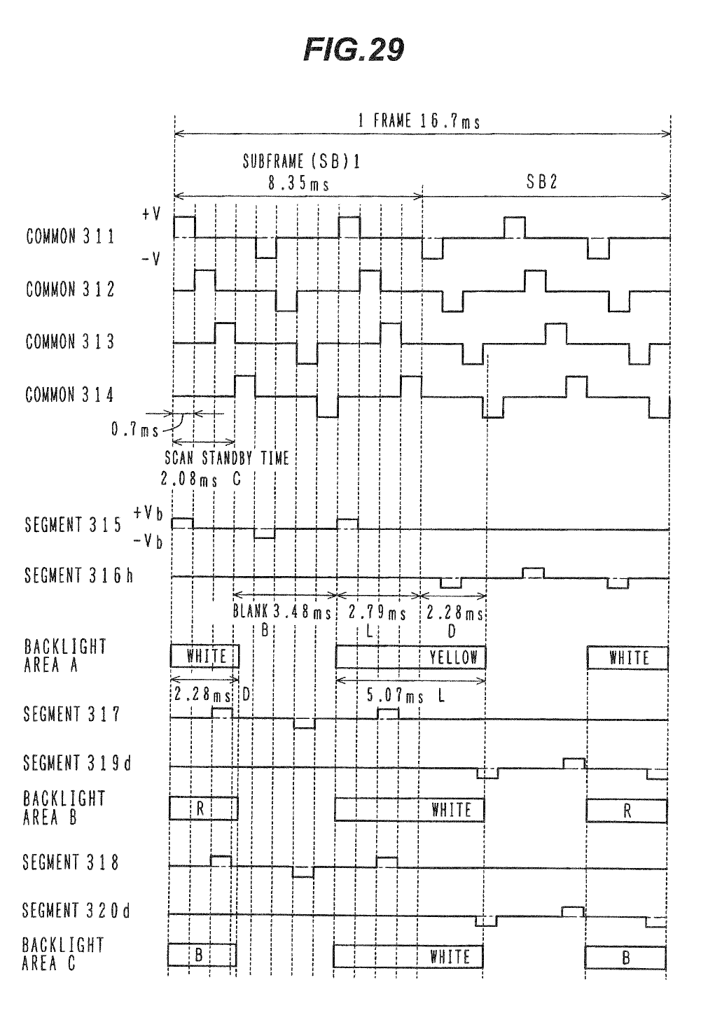

FIG. 29 is a timing chart showing timings of drive waveforms at a 1/4 duty and 1/3 bias applied across the common electrodes 311 to 314 and the segment electrodes 315, 316h, 317, 318, 319d and 320d and emission of the backlight in the display areas A to C.

Similar to the eighth embodiment, a common select voltage is set to ±V, and a pixel enters an on-state when ±Vb is applied to the segment. However, in the tenth embodiment, since the liquid crystal display unit is assumed to be a VA unit, the on-state is bright display and the off-state is dark display.

Similar to the eighth embodiment, one frame was set to 16.7 ms and divided at an equal pitch into two subframes. One subframe time is about 8.35 ms. A drive frequency of multiplex driving waveforms applied to the liquid crystal display unit was set to about 180 Hz. A scan time per common electrode is about 0.7 ms and a scan standby time is about 2.08 ms.

A current subframe backlight time L for turning on the backlight of emission color corresponding to the display pattern of the subframe is set to a period after a scan standby time of 2.08 ms after the start time of the subframe and after about 3.48 ms (refer to the static driving shown in FIG. 15A) for awaiting a fall response completion of the VA unit to the end time of the subframe. The current subframe backlight emission time L is about 2.79 ms.

In the tenth embodiment, a preceding subframe backlight emission time D is set starting from the start time of the subframe by prolonging the turn-on of the backlight of emission color corresponding to the display pattern of the subframe immediately before. The preceding subframe backlight emission time D is set to a rise response lag time of 2.28 ms (refer to the 1/4 duty and 1/3 bias driving shown in FIG. 15B) of the VA unit.

The backlight emission time per one color is about 5.07 ms prolonged by 2.28 ms from 2.79 ms, because the preceding subframe backlight emission time is incorporated. By prolonging the backlight emission time, it is expected that a display luminance can be improved.

Visual states were compared between the liquid crystal display device using a VA unit driven by the method of the tenth embodiment shown in the timing chart of FIG. 29 and the device driven by the method similar to the eighth embodiment shown in the timing chart of FIG. 27 (the driving method not incorporating the preceding subframe backlight emission time). In the driving method not incorporating the preceding subframe backlight emission time similar to the eighth embodiment, since the VA unit is used, on/off of the drive waveform was reversed from that of the eight embodiment, and the blank time to be set after the scan standby time 2.08 ms was set to about 3.48 ms and the backlight emission time was set to about 2.79 ms. It was confirmed that a display luminance of the tenth embodiment was improved definitely.

One subframe time S is represented by S=D+B+L if C<D and by S=D+(C−D)+B+L if C>D, where C is a scan standby time, D is a preceding subframe backlight emission time, B is a blank time and L is a current subframe backlight emission time.

In the subframe, awaiting a fall response time, the current subframe backlight emission time L is set for turning on the emission color corresponding to the subframe. However, if the fall response time becomes very long due to a low temperature or the like, the fall response completion may reach the end time of the subframe. In this case, the current subframe backlight emission time L is 0.

However, if the backlight of this emission color is turned on during the initial stage of the next subframe, the emission time can be retained. Namely, even if the current subframe backlight emission time L is 0, the preceding subframe backlight time D is set not to 0 and the emission time can be retained.

The FS driving method incorporating the preceding subframe backlight emission time can be applied to the case in which the backlight of emission color corresponding to the display pattern of a subframe is not turned on during the subframe, but it is turned on during the subframe immediately thereafter.

With the FS driving method incorporating the preceding subframe backlight emission time, even if the current subframe backlight emission time L is not 0 or is 0, the backlight of emission color corresponding to the display pattern of the subframe is turned on during a period from some time point in the subframe to some time point in the subframe immediately thereafter.

As described above, a scan standby time C is represented by C=(N−1)/(f×2N), wherein S is a one subframe time, N (1/N duty driving) is the number of common electrodes of a liquid crystal display unit, and f is a drive frequency of the liquid crystal display unit. A sum of the preceding subframe backlight emission time D and blank time B is preferably set not shorter than a sum of the scan standby time SM and liquid crystal display unit fall response time.

In the liquid crystal display devices of the seventh to tenth embodiments, the color break-less FS driving is performed for each display area set to each group of segment electrodes. Therefore, for example, it is possible to reduce the number of subframes necessary for one frame so that a backlight emission time can be prolonged and a display luminance can be improved.

In the embodiments described above, although the subframes are set by equal division, the subframes may be set by unequal division. The number M of subframes is not smaller than 2. One frame period may be made different for each frame or for a plurality of frames, and the subframe time is changed correspondingly.

In the above-described embodiments, the static driving and the 1/4 duty and 1/3 bias multiplex driving have been considered. The duty is not limited to the 1/4 duty, but it may be a 1/2 to 1/16 duty, preferably a 1/2 duty to 1/9 duty.

The liquid crystal display devices and FS driving methods of the seventh to tenth embodiments may be applied to the following products. The products include a vehicle mounted information display device having a segment display unit or a segment display unit and a dot matrix display unit, a display unit for car audio, and an operation panel display unit of a business machine such as a copy machine.

Next, description will be made on liquid crystal display devices according to the eleventh to thirteenth embodiments.

In the liquid crystal display device under multiplex driving, as the display capacity increases and the number of scan lines increases, a response speed of liquid crystal lowers so that a display luminance and color purity of the display unit may be degraded or a display may have a flicker. This tendency is increased particularly in the case wherein the display unit has a dot matrix display unit.

For the liquid crystal display having a display unit having segment display or a mixture of segment display and dot matrix display, it has been long desired to provide techniques capable of color break-less FS driving with an improved display luminance and color purity during multicolor display.

With reference again to FIG. 1, description will be made on the common structure to FS driving liquid crystal display devices according to the seventh to tenth embodiments.

A liquid crystal display unit has at least one common electrode and a plurality of groups of segment electrodes for segment display facing the common electrode.

Display areas (e.g., A and B) are formed for groups of segment electrodes and correspond to display areas of the backlight 2.

The backlight 2 is disposed on the back of the liquid crystal display unit 1, and includes a multicolor light source LS disposed for each display area and a light distribution control structure for making light emitted from each multicolor light source LS be radiated only to a corresponding display area. Each multicolor light source LS is constituted of an LED capable of emitting a single color or a plurality of colors, and can be tuned on at an independent timing.

The drive unit 3 synchronously drives the liquid crystal display unit 1 and each backlight 2 at desired timings. The backlight 2 radiates the same color always at least during one frame or a plurality of colors through color break-less FS driving, depending upon each display area. In the color break-less FS driving, bright display of each segment display unit is performed only in one subframe per frame, and a desired color display is obtained by primary color display or mixture color display through simultaneous emission of a plurality of light sources, respectively in one subframe.

The liquid crystal display unit 1 may be an NWTN mode liquid crystal display unit (refer to FIGS. 2A to 2C and corresponding description), a two-layer TN mode liquid crystal display unit (refer to FIG. 3 and corresponding description) or a VA mode liquid crystal display unit (refer to FIG. 4 and corresponding description).

### Eleventh Embodiment

The present inventor has studied a display method for a liquid crystal display unit and has invented a display method of displaying a partial display area with the same color always during one frame and displaying the other display area with a plurality of colors by FS driving.

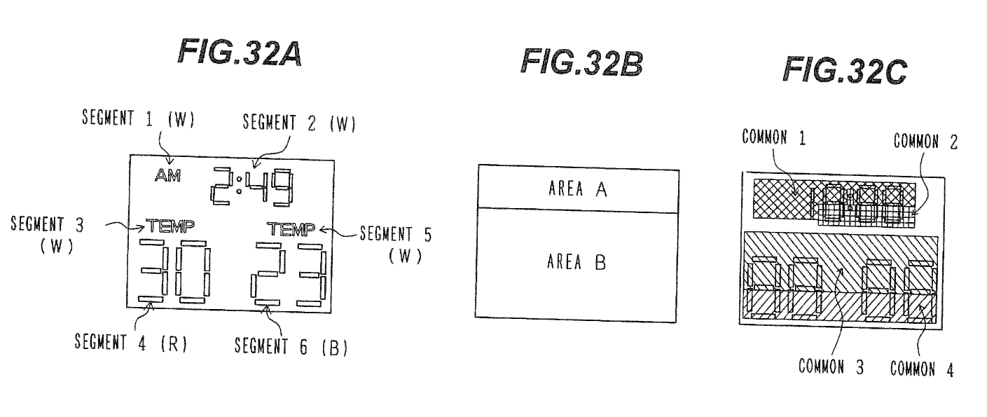

FIG. 32A shows a display example 1 of a liquid crystal display unit. In the display example 1, a clock display unit is disposed at an upper stage, a temperature display unit is disposed at a lower stage, and the clock display unit is always white display. Color of the temperature display unit is desired to be changed.

In FIG. 32A, a segment 1 displays “AM” of the clock display unit in white display color. A segment 2 displays “: (colon)” of the clock display unit in white display color. 7-segment units of four digits of the clock display unit are also displayed in white display color. A segment 3 displays “TEMP” at the left of the temperature display unit in white display color. A segment 4 displays the lowermost horizontal bar of a 7-segment unit at the second digit in red display color. All seven segments at the left of the temperature display unit are displayed in red display color, and the segment 4 is derived as a representative segment of seven segments. Similarly, a segment 6 is derived as a representative segment of seven segments at the right of the temperature display unit, and displays the lowermost horizontal bar of the second digits. The segment 6 is displayed in blue display color. A segment 5 displays “TEMP” at the right of the temperature display unit in white display color.

FIG. 32B shows an assignment example 1 of backlight areas. As shown in FIG. 32B, a backlight area disposed on the back of the liquid crystal display unit is divided into backlight areas A and B at a position between the clock display unit and temperature display unit. A drive unit is provided for turning on a light source independently in each backlight area.

The backlight may be the side light type described with reference to FIG. 6 or the just-under type described with reference to FIG. 7.

In order to prevent a backlight beam from leaking from one area to another, a shortest distance between segment display units included in adjacent display areas (shortest distance between display pixels) is preferably not shorter than 1 mm and more preferably not shorter than 2 mm. In the display example, a distance between the lowermost end of the clock display unit (area A) and the uppermost end of the temperature display unit (area B) is set to 2.5 mm.

FIG. 32C shows an example of common electrode wirings. As shown, the clock display unit is connected to common electrodes 1 and 2, and the temperature display unit is connected to common electrodes 3 and 4.

A select signal is applied to the segment 1 at a timing when the common electrode 1 is scanned, to the segment 2 at the timing when the common electrode 2 is scanned, to the segments 3 and 5 at the timing when the common electrode 3 is scanned, and to the segments 4 and 6 when the common electrode 4 is scanned. As shown, the 7-segment units of four digits of the clock display unit correspond to the common electrode 1 or 2, and other segments of the temperature display unit correspond to the common electrode 3 or 4.

### Embodiment 11-1

Next, voltage waveforms are shown to be applied to each common electrode and each segment electrode. In this example, description will be made by using an NWTN type having a metal black mask in a non-display area.

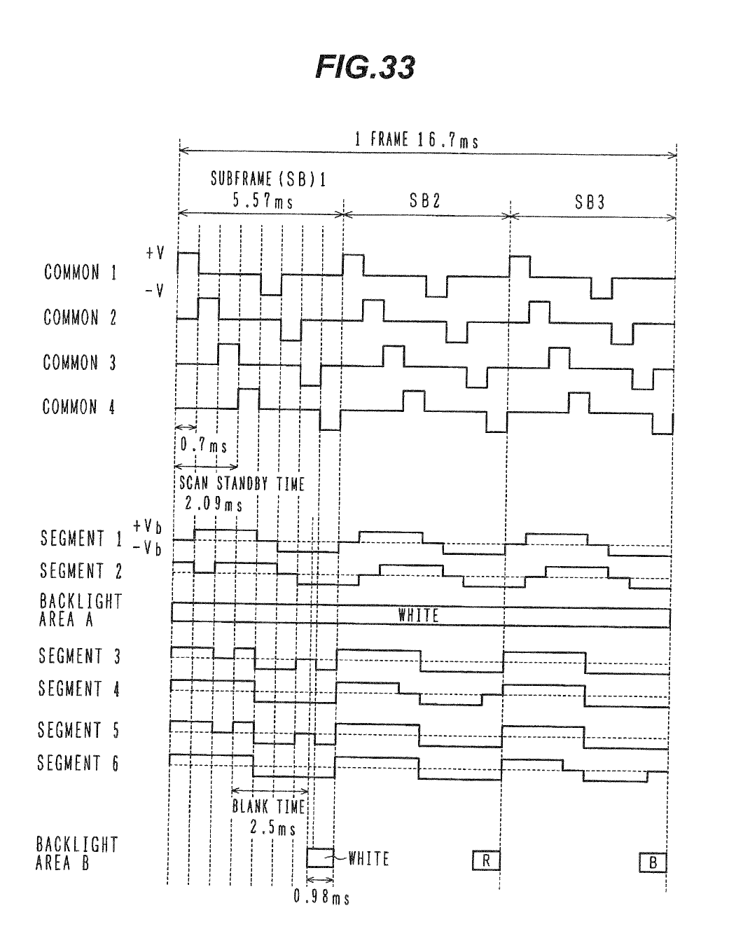

FIG. 33 is a timing chart showing timings of drive waveforms applied to common electrodes 1 to 4 and segment electrodes 1 to 6 in one frame and emission of the backlight areas A and B. Emission colors are also shown. A color break-less driving method is used as the FS driving method. As one frame is set to about 16.7 ms, the number M of subframes is set to “3” because four display colors, white (W), red (R), blue (B) and black (BK), are used. The frame is divided at equal pitch into subframes of about 5.57 ms each. A voltage applied to the liquid crystal display unit is a multiplex drive voltage at a 1/4 duty, a 1/3 bias and a frame frequency f of 360 Hz. The number N of all scan (common) lines is “4”, and a scan standby time C is set to about 2.09 ms from C=(N−1)/(f×N).

As a blank time for awaiting a response time of the NWTN liquid crystal display unit is set to about 2.5 ms, a backlight emission time in a subframe is about 0.98 ms. However, since the clock display unit is displayed always in white color, this backlight emission time is applied only to the backlight area B. A white display luminance is compared between the backlight areas A and B. If no countermeasure is provided, there is a large luminance difference because a white color emission time in one frame has a difference not smaller than 17 times between the areas A and B. In order to eliminate this luminance difference, it is necessary to lower a luminance in the area A or increase a luminance in the area B, by some countermeasure.

In order to lower the luminance in the area A, the countermeasure is to reduce the number of light sources in the area A or to reduce current to be flowed through a unit constituting a light source.

### Embodiment 11-2

Description will be made on a method of improving a display luminance of the area B. In order to improve a display luminance of the area B, it is sufficient if an emission time per subframe is prolonged.

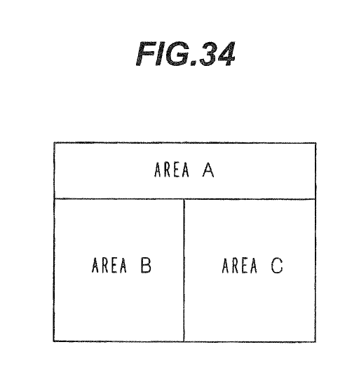

FIG. 34 shows an assignment example 2 of backlight areas. As shown, the present inventor divides the area into three areas A, B and C. The area A corresponds to a clock display unit, the area B corresponds to a left temperature display unit, and the area C corresponds to a right temperature display unit. Emission of black+two colors (two colors may differ in the areas B and C) was performed. In this manner, an emission time per subframe is prolonged by reducing the subframe number M to “2”.

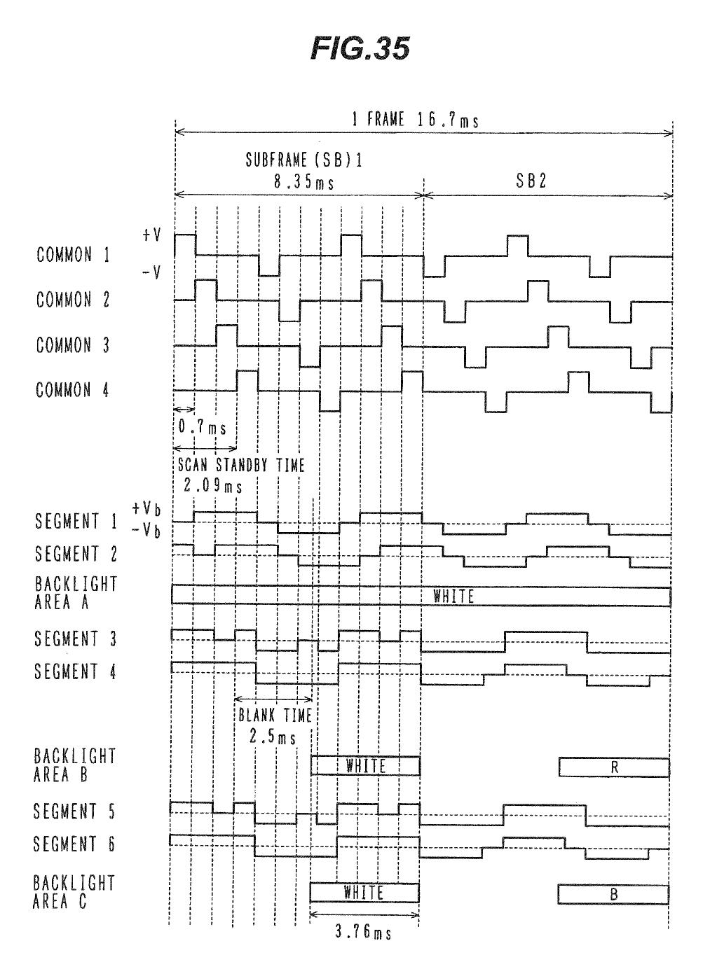

FIG. 35 is a timing chart showing timings of drive waveforms applied to common electrodes 1 to 4 and segment electrodes 1 to 6 and emission of the backlight areas A, B and C. Emission colors are also shown. One frame time is the same as that of the embodiment 11-1, the subframe number M was set to “2”, and one frame time was set to about 8.35 ms. The multiplex drive waveforms are the same as those of the embodiment 11-1 so that the scan standby time C is also about 2.09 ms. A backlight emission time L in the areas B and C is 3.76 ms which is 3.8 times that of the embodiment 11-1. A luminance difference between the backlight area A and the backlight areas B and C is 4.5 times smaller than that of the embodiment 11-1. The liquid crystal display device was actually manufactured and visually observed. It was confirmed that the luminance difference was improved considerably. The liquid crystal display unit is the NWTN type similar to the embodiment 11-1.

### Embodiment 11-3

In FIG. 32C, the wirings of the common electrodes 3 and 1 may be exchanged and the wirings of the common electrodes 4 and 2 may be exchanged. In the backlight area division shown in FIG. 32B, the backlight area A is displayed always in white color, and the area B is displayed intermittently by FS driving.

The present inventor has invented a method of prolonging a backlight emission time by using only one common electrode covering an intermittent display area, or if a plurality of common electrodes are used, by scanning the electrodes side by side and turning on the backlight at this scan timing.

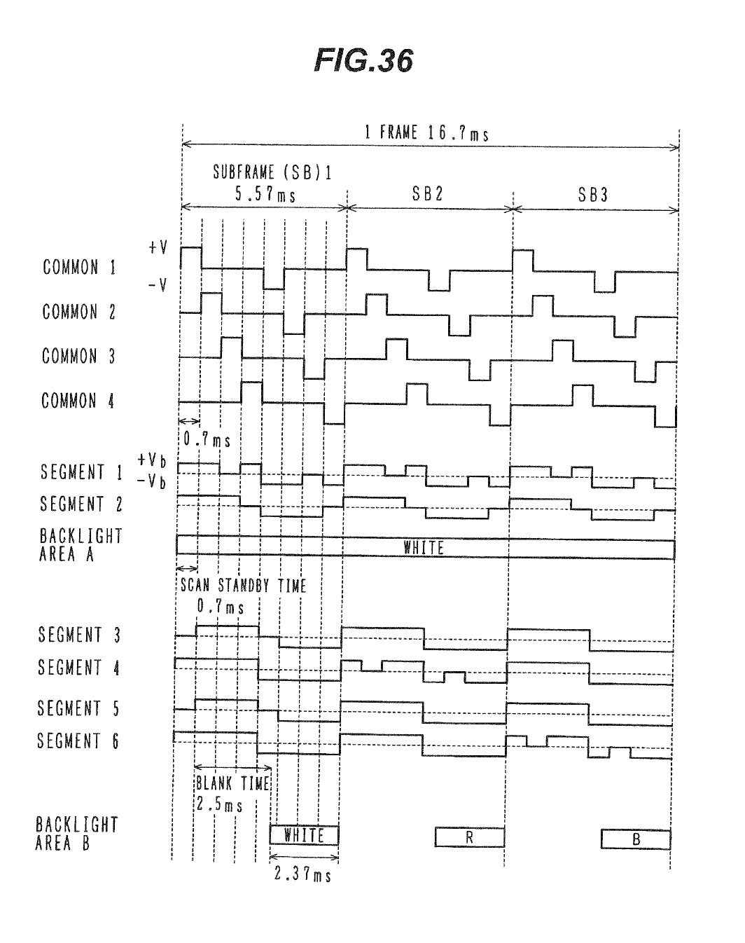

FIG. 36 is a timing chart showing timings of drive waveforms applied to common electrodes 1 to 4 and segment electrodes 1 to 6 in one frame and emission of the backlight areas A and B. Emission colors are also shown. Similar to the timing chart of FIG. 33, one frame is equally divided into three subframes, and time settings of each period are similar to those of the embodiment 11-1. However, a scan standby time is different from that of the embodiment 11-1, and is 0.7 ms in the embodiment 11-3. As shown in FIG. 36, a backlight emission time in the area B is about 2.37 ms which is about 2.8 times that of the embodiment 11-1. A segment luminance in the area B is about 1/6 that in the area A in a continuous emission state, and a luminance difference is therefore improved more than that of the embodiment 11-1.

The liquid crystal display device of the embodiment 11-3 was actually manufactured and its visual states were observed. It was confirmed that a luminance difference between the backlight areas A and B was improved more than that of the embodiment 11-1.

In this embodiment, the layout of common electrodes is set in such a manner that common signals 1 and 2 (first and second signals in each subframe) are applied to each common electrode corresponding to the temperature display unit. Instead, wirings may be made in such a manner that voltages applied to each common electrode corresponding to the temperature display unit is aligned side by side on the time axis. In this case, during the period from when the backlight is turned on in a current subframe to when a common signal corresponding to the common electrode is applied in the next subframe, emission of the backlight of the same color can be continued so that a long backlight emission time becomes possible.

### Embodiment 11-4

By adopting the assignment example 2 of backlight areas shown in FIG. 34, the subframe number M can be set to “2”, and the drive sequence of the embodiment 11-3 is combined. As the scan standby time is set to about 0.7 ms and the blank time B is set to about 2.5 ms, the backlight emission time L is about 5.15 ms. A luminance can be set to about 1/3 that of a continuous emission area so that a visual luminance difference reduces and a good display quality can be realized.

### Twelfth Embodiment

In the above-described embodiments, the NWTN type is adopted as the liquid crystal display unit. Next, description will be made on a driving method using a normally black mode two-layer TN type and VA type. As the two-layer type or VA type is used as the liquid crystal display unit there is a tendency that a response time becomes longer than using the NWTN type. Since there is a fear that a response speed lowers further under a large duty condition, it is necessary to have a long blank time, resulting in a short backlight emission time and a lowered display luminance.

As will be described hereunder, a display luminance may be improved by prolonging a backlight emission time to a rise response lag time of a liquid crystal display unit (refer to description made with reference to FIGS. 15A and 15B and the fifth and sixth embodiments).

### Embodiment 12-1

First, description will be made by using the VA type as the liquid crystal display unit. The display pattern is the same as that shown in FIG. 32A. The backlight area is divided into the areas A and B shown in FIG. 32B. Wirings for the common electrodes and segment electrodes, one frame time and one subframe time are the same as those of the embodiment 11-3. In this embodiment, a “preceding subframe (SB) backlight emission continuation time” is provided so that in the state that the backlight is turned on in a subframe, the backlight is continued to be turned on for a predetermined time even after switching to the next subframe. This utilizes a slow response speed of a two-layer TN type liquid crystal cell. Namely, during the period while a transmittivity of the liquid crystal display unit changes hardly even if an electric signal changes, the backlight of the same color is continued to be turned on to thereby prolong an emission time and improve a luminance.

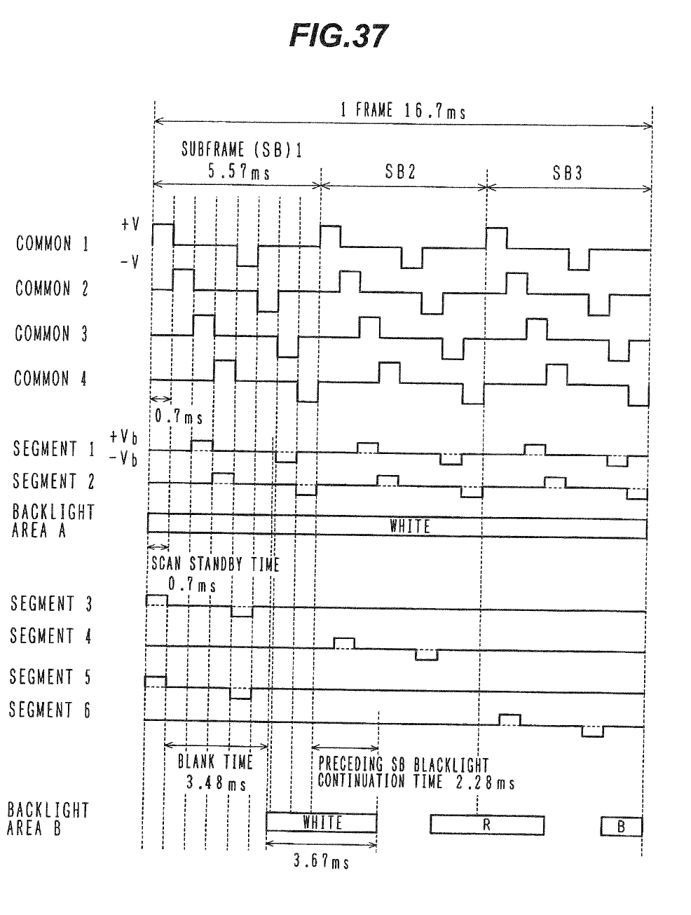

FIG. 37 is a timing chart showing timings of drive waveforms applied to common electrodes 1 to 4 and segment electrodes 1 to 6 in one frame and emission of the backlight areas A and B. Emission colors are also shown in FIG. 37.

One subframe time is represented by S, a preceding SB backlight emission continuation time (including a scan standby time C) is represented by D, a blank time is represented by B and a backlight emission time is represented by L. A pattern can be displayed without lowering color purity if D>0 even if L=0 and S=D+B.

A scan standby time C is represented by C=(NN=1)/(f×N) where NN is the number of scan lines in a display area under FS driving, N is the total number of scan lines, and f is a frame frequency.

A sum D+B of the preceding backlight emission continuation time D and blank time B is preferably set not shorter than a sum of the scan standby time C and a response time taken to change from bright display to dark display of the liquid crystal display unit.

The scan standby time C of the embodiment 12-1 is about 0.7 ms at a frame frequency f of 360 Hz. The preceding SB backlight emission continuation time D is set to about 2.28 ms which corresponds to a response lag time of the VA type liquid crystal display unit under 1/4 duty and a 1/3 bias driving, as shown in FIG. 37. The blank time B is set to 3.48 ms. Therefore, the preceding SB backlight emission time is 1.39 ms. The same backlight emission time Lsc is L+D=3.7 ms which is about 2.64 times that of L and can obtain the improved luminance effects. The (same color) backlight emission time in the backlight area B is about 1/5 that of the backlight area A.

The liquid crystal display device of the embodiment 12-1 was manufactured and visual states were observed. The improved luminance effects were obtained.

### Embodiment 12-2

In order to realize the display of the embodiment 12-1, the backlight area may be divided as shown in FIG. 34. In this case, a backlight emission time L in one subframe is about 4.17 ms, and the same color backlight emission time Lsc is about 6.45 ms as a sum of the emission time L and the preceding SB backlight emission time D. Since the (same color) backlight emission time in the backlight area B is about not shorter than 1/3 that in the backlight area A, the drive sequence of this embodiment can expect the further improved luminance effects.

### Embodiment 12-3

Although the embodiments 12-1 and 12-2 use the VA type liquid crystal cell as the liquid crystal display unit, the embodiments may be applied to a two-layer TN type liquid crystal display device. By using the drive sequence of the embodiment 12-1, a blank time is 2.24 ms as shown in FIG. 15A, and a backlight emission time L is 5.57−0.7−2.24=2.63 ms. A preceding SB backlight emission continuation time D may be set to 4.12 ms as shown in FIG. 15B. Since one subframe is 5.57 ms, the same color backlight emission time Lsc is 5.57 ms at a maximum.

### Embodiment 12-4

As in the embodiment 12-2, as the backlight area is divided such as shown in FIG. 34, the subframe number M can be set to “2”, and a time per subframe is about 8.85 ms. In this case, a backlight emission time 1 is 8.85−2.94=5.91 ms. In this case, the same color backlight emission time Lsc is 8.85 ms at a maximum so that the further improved luminance effects can be obtained.

### Thirteenth Embodiment

The display pattern is not limited to those described above.

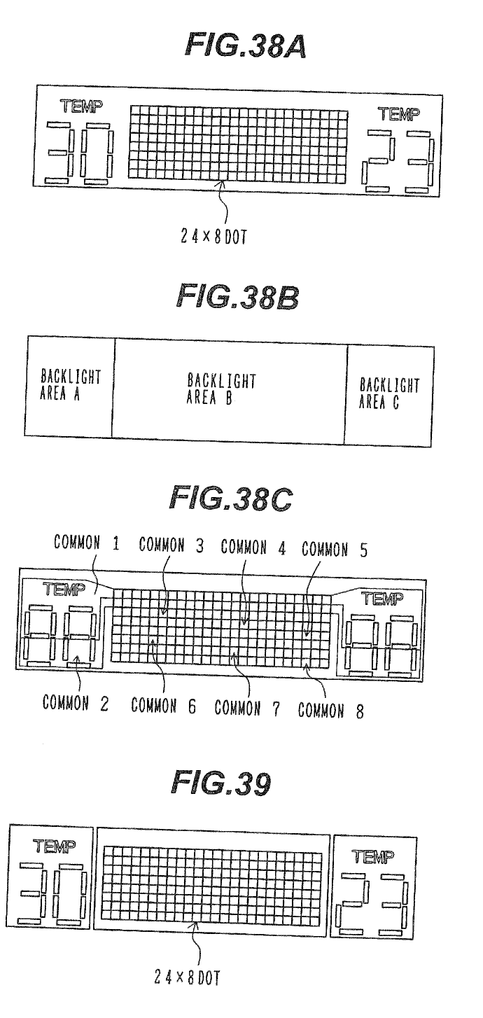

FIG. 38A shows a display pattern example 2. The display pattern shown in FIG. 38A is a mixed pattern of segment display units and a dot matrix display unit. As shown, the display pattern 2 has segment display units for displaying temperatures at the right and left. In the temperature display units, “TEMP” display units are white display. 7-segment display units of two digits at the right and left are red (R) display at the left and blue (B) display at the right. White display is performed for all dots in the 24×8 dot matrix unit at the center.

FIG. 38B shows a division example of backlight areas. As shown, the backlight area is divided into three areas: right and left temperature display units (areas A and C) and a dot matrix display unit (area B). The area B is in a continuous emission state, and the areas A and C are under FS driving.

FIG. 38C is a wiring diagram of common electrodes. As shown, common electrodes 1 to 8 are wired for 1/8 duty and 1/4 bias driving. Common electrodes corresponding to the segment display units are disposed side by side (in the example shown, wired to the common electrodes 1 and 2) so that a backlight emission time can be prolonged similar to the embodiment 11-3. It is however necessary to set a period of a drive frequency not longer than one subframe time (in the case of two subframes, not longer than 8.35 ms).

A display color of the area B is not limited to white, but a plurality of colors may be displayed by using a multicolor light source.

Although the present invention has been described in connection with the embodiments, the present invention is not limited only to these embodiments. For example, subframes may not be set through equal time division but may be set through unequal division. One frame time may be changed for each frame.

FIG. 39 shows a display pattern example 3. As shown, a display pattern is divided and each divided area may be driven by an independent wiring. Each divided display area may be driven by a separate liquid crystal cell. In this case, synchronization is made only when a display state is changed, and synchronization is not necessary in the state that a display state is unchanged.

Multiplex driving at a 1/2 duty to 1/16 duty is preferably (in terms of display quality) at a 1/2 duty to 1/9 duty. If each divided area is driven by an independent wiring as shown in FIG. 38, multiplex driving at a 1/2 duty to 1/8 duty or preferably at a 1/2 duty to 1/4 duty can be performed. A driving method may be a static driving method.

Of backlight areas (display areas), there may exist a plurality of areas in a continuous emission state. A display area in the continuous emission state may be controlled to be switched in the frame unit basis of a drive waveform.

The present invention has been described in connection with the embodiments. The present invention is not limited only to these embodiments, but it is obvious that various modifications, improvements, combinations and the like can be made by those skilled in the art.

What is claimed is:

1. A liquid crystal display device comprising:
a liquid crystal display unit including a plurality of divided display areas;
a backlight having a light source provided for each of said plurality of divided display areas; and
a drive unit for synchronizing a display state of said liquid crystal display unit and an emission state of said backlight.

2. The liquid crystal display device according to claim 1, wherein:
said liquid crystal display unit includes a plurality of common electrodes to be sequentially applied with a drive voltage and a segment electrode or segment electrodes for segment display, facing each common electrode, and said display area is provided for one or more common electrodes;
each light source of said backlight provided for each of said display areas includes a multicolor light source; and
said drive unit performs field sequential driving of multiplex driving by scanning said plurality of common electrodes in such a manner that after all common electrodes in one display area are scanned, a common electrode or electrodes in the next display area start being scanned, and by synchronizing scanning each common electrode with an emission operation of said multicolor light source in each of said display areas.

3. The liquid crystal display device according to claim 2, wherein a shortest distance between display units in adjacent display areas is not shorter than 1 mm.

4. The liquid crystal display device according to claim 2, wherein said liquid crystal display unit includes a common electrode under multiplex driving at a 1/2 duty to 1/8 duty, and said drive unit performs multiplex driving at a 1/2 duty to 1/8 duty, correspondingly.

5. The liquid crystal display device according to claim 2, wherein the number of display areas is 4 or smaller.

6. The liquid crystal display device according to claim 2, wherein each of said display areas corresponds to one common electrode.

7. The liquid crystal display device according to claim 2, wherein the number of common electrodes corresponding to a first display area among said plurality of display areas is larger than the number of common electrodes corresponding to a second display area, and field sequential driving for the second display area is performed at a timing shifting a timing of field sequential driving for the first display area by a predetermined time.

8. The liquid crystal display device according to claim 2, wherein said drive unit controls the emission state of said backlight in such a manner that emission color corresponding to a display pattern of an arbitrary first subframe among a plurality of subframes obtained through division of a frame is displayed during a period from some time in said first subframe to some time in a second subframe immediately after said first subframe.

9. The liquid crystal display device according to claim 8, wherein said drive unit displays the emission color corresponding to the display pattern of said first subframe during a period from a start time of said second subframe to a rise response lag time from dark display to bright display of said liquid crystal display unit.

10. The liquid crystal display device according to claim 2, wherein said liquid crystal display unit is a normally black type.

11. The liquid crystal display device according to claim 2, wherein said drive unit performs color break-less field sequential driving by controlling said liquid crystal display unit in such a manner that each display unit displayed by said segment electrode or segment electrodes becomes bright display only in one subframe per frame, and by controlling said backlight in such a manner that the light source of a plurality of colors becomes under emission at the same time in some subframe.

12. The liquid crystal display device according to claim 1, wherein:
said liquid crystal display unit includes a common electrode structure having at least one common electrode and a plurality of groups of segment electrodes for segment display, facing said common electrode structure, and said divided display area is provided for each group of segment electrodes;
each light source of said backlight provided for each of said display areas includes a multicolor light source; and
said drive unit performs color break less field sequential driving in each of said display areas by controlling said liquid crystal display unit in such a manner that each display unit displayed by said segment electrodes becomes bright display only in one subframe per frame, and by controlling said multicolor light source in such a manner that an arbitrary light source is turned on in each subframe.

13. The liquid crystal display device according to claim 12, wherein a shortest distance between display units in adjacent display areas is not shorter than 1 mm.

14. The liquid crystal display device according to claim 12, wherein said backlight further includes a light distribution structure for guiding each light beam emitted from said multicolor light source to a corresponding display area.

15. The liquid crystal display device according to claim 12, wherein said liquid crystal display unit includes said common electrode structure under static driving or multiplex driving at a 1/2 duty to 1/16 duty, and said drive unit performs static driving or multiplex color break-less field sequential driving at a 1/2 duty to 1/16 duty, correspondingly.

16. The liquid crystal display device according to claim 12, wherein said drive unit controls the emission state of said backlight in such a manner that emission color corresponding to a display pattern of an arbitrary first subframe is displayed during a period from some time in said first subframe to some time in a second subframe immediately after said first subframe.

17. The liquid crystal display device according to claim 16, wherein said drive unit displays the emission color corresponding to the display pattern of said first subframe during a period from a start time of said second subframe to a rise response lag time from dark display to bright display of said liquid crystal display unit.

18. The liquid crystal display device according to claim 12, wherein said liquid crystal display unit is a normally black type.

19. The liquid crystal display device according to claim 1 wherein:
said liquid crystal display unit includes a common electrode structure having at least one common electrode and a plurality of groups of segment electrodes for segment display or dot matrix display in said plurality of display areas, said segment electrodes facing said common electrode structure, and said divided display area is provided for each group of segment electrodes; and
said drive unit performs continuous emission or extinction of the light source in at least any one of said plurality of display areas and performs intermittent emission of the light source in at least one of the others of said plurality of display areas; and
said drive unit further performs color break-less field sequential driving through emission of the same color at least in one frame in the display area of light source continuous emission and by bright display only in one subframe per frame in the display area of light source intermittent emission.

20. The liquid crystal display device according to claim 19, wherein a shortest distance between display units in adjacent display areas is not shorter than 1 mm.

21. The liquid crystal display device according to claim 19, wherein said backlight further includes a light distribution structure for guiding each light beam emitted from said multicolor light source to a corresponding display area.

22. The liquid crystal display device according to claim 19, wherein:
said common electrode structure has a wiring pattern allowing static driving or multiplex driving at a 1/2 duty to 1/16 duty; and
said drive unit performs static driving or multiplex driving at a 1/2 duty to 1/16 duty.

23. The liquid crystal display device according to claim 19, wherein said drive unit can switch between continuous emission and intermittent commission in each of said display areas.

24. The liquid crystal display device according to claim 19, wherein said liquid crystal display unit is a normally white mode twist nematic (TN) type.

25. The liquid crystal display device according to claim 19, wherein said liquid crystal display unit is a normally black mode, vertical alignment or two-layer type.

26. A drive method for a liquid crystal display device having a liquid crystal display unit including a common electrode structure having at least one common electrode and a plurality of groups of segment electrodes for segment display or dot matrix display in a plurality of display areas, the segment electrodes facing said common electrode structure, a plurality of backlights provided in correspondence with the plurality of display areas, and a drive unit for driving independently the plurality of backlights and synchronously driving the liquid crystal display unit and the plurality of backlights, wherein said drive unit performs continuous emission or extinction of the backlight in at least any one of said plurality of display areas and performs intermittent emission of the backlight in at least one of the others of said plurality of display areas, the drive method for a liquid crystal display device comprising a step of:
performing color break-less field sequential driving through emission of the same color at least in one frame in the display area of continuous emission and by bright display only in one subframe per frame in the display area of intermittent emission.

27. The drive method for a liquid crystal display device according to claim 26, wherein said drive unit applies scan signals to a plurality of common electrodes connected to the display area under sequential driving side by side along a time axis.

28. The drive method for a liquid crystal display device according to claim 26, wherein said drive unit continues emission of the same color by a predetermined time even after a current subframe under emission of the backlight is switched the next subframe in the display area under sequential driving.

29. The drive method for a liquid crystal display device according to claim 26, wherein said liquid crystal display unit is a normally white mode twist nematic (TN) type.

30. The drive method for a liquid crystal display device according to claim 26, wherein said liquid crystal display unit is a normally black mode, vertical alignment or two-layer type.
